(19) United States
(12) Patent Application Publication
(10) Pub. No.: US 2026/0228151 A1
(43) Pub. Date: Aug. 6, 2026

(54) USB-C MIDSPAN CHARGING AND BI-DIRECTIONAL DATA COMMUNICATION DEVICE

(71) Applicant: Crestron Electronics, Inc., Rockleigh, NJ (US)

(72) Inventors: Marc Dubowski, Fishkill, NY (US); William Owens-Davidson, Cresskill, NJ (US); David Bogdanove, RIngwood, NJ (US); Mark LaBosco, New City, NY (US); Vitaly A Perlin, Stamford, CT (US)

(73) Assignee: Crestron Electronics, Inc., Rockleigh, NJ (US)

(21) Appl. No.: 19/230,279

(22) Filed: Jun. 6, 2025

Related U.S. Application Data
(60) Provisional application No. 63/753,096, filed on Feb. 3, 2025.

(51) Int. Cl. G06F 13/38; G06F 13/42

(52) U.S. Cl. CPC G06F 13/382; G06F 13/4282; G06F 2213/40

(57) ABSTRACT

A midspan charging and data communication device is disclosed. A first USB-C port is electrically connectable to a USB-C host device. A second USB-C port is electrically connectable to a USB-C peripheral device. USB-C midspan device processor and circuitry is electrically connected to the first and the second USB-C ports, configures the first USB-C and second USB-C ports to support USB data communication in a particular USB data link mode, and at least one of (i) delivers power as requested by the USB-C host device from the first USB-C port to the USB-C host device over a first data link between the USB-C host device and the first USB-C port or (ii) delivers power as requested by the USB-C peripheral device from the second USB-C port to the USB-C peripheral device over a second data link between the USB-C peripheral device and the USB-C second port.

### CROSS-REFERENCE TO RELATED APPLICATIONS

This application claims the benefit of the filing date of United States Provisional Patent Application No. 63/753,096, filed Feb. 3, 2025, the disclosure of which is incorporated herein by reference.

### BACKGROUND OF THE INVENTION

### Technical Field

The embodiments described herein relate generally to providing charging power and to data and video communication and, more specifically, to devices that facilitate USB-C bi-directional data and/or video communication between a Universal Serial Bus Type-C (USB-C) host device and at least one USB-C peripheral device while delivering charging power to one or more of these devices.

### Background Art

In many enterprises, conference rooms are employed for meetings where presentations are given by one or more of the participants. Typically, such presentations are stored on a laptop computer or the like. It is also increasingly common for such conference rooms to have a sophisticated interactive audio-video (AV) conference room system, such as a system that includes remote and/or long distance access and where the presentation subject matter may be presented on one or more displays. These AV conference room systems may also include one or more microphones, cameras, and speakers, as well as one or more other devices that may interconnect with the laptops of the participants.

Each of these devices and laptops consumes electrical power and requires occasional charging. Often, there is an insufficient number of outlets in the conference room to charge all of the laptops and other devices of the participants. It is therefore possible that a participant's laptop could cease working during a meeting because of a lack of power outlets or, more critically, that a presenter's laptop could cease working during a presentation, which is even more problematic. Moreover, some laptops, such as a Mac®, provide only a single connection for all input and output (I/O). Therefore, it would be advantageous to be able to use this single connection to charge the laptop while the laptop is connected to other non-charging (I/O) peripherals.

As is known in the art, a peripheral device may comprise a docking station, a video dongle, a conference phone, a mouse, or a keyboard-video-mouse (KVM) switcher, as well as other types of peripheral devices. Though a docking station may be able to provide some power to the laptop, none of the other peripheral device have this capability. Moreover, not all conference rooms have docking stations that are compatible with every type of laptop or with other types of data providing devices.

It is therefore desirable to have the capability of providing charging power to a host device, such as a laptop, while concurrently facilitating bi-directional data and video communication between that host device and a peripheral device.

It is further desirable to have the capability of providing such charging power to a Universal Serial Bus Type-C (USB-C) host device and/or a USB-C peripheral device while facilitating USB-C bi-directional data and/or video communication between that USB-C host device and the USB-C peripheral device.

It is still further desirable to provide such charging power to a USB-C host device and/or a USB-C peripheral device over one or more of the data links where the USB-C bi-directional data and/or video communication is facilitated.

It is yet further desirable provide a device, such as a midspan device, that facilitates USB-C bi-directional data and/or video communication between a USB-C host device and a USB-C peripheral device while delivering charging power to one or more of these devices over one or more of the data links where the bi-directional data and/or video communication is facilitated.

It is also desirable to provide devices, systems, methods, processes, and modes for facilitating USB-C bi-directional data and/or video communication between the USB-C host device and the USB-C peripheral device while delivering charging power to one or more of these devices over one or more of the data links where the bi-directional communication is facilitated, the charging power delivery and USB-C bi-directional data and video communication support being through a device, such as a midspan device.

### SUMMARY OF THE INVENTION

The present embodiments provide devices, systems, methods, processes, and modes for facilitating USB-C bi-directional data and/or video communication between a Universal Serial Bus Type-C (USB-C) host device and at least one USB-C peripheral device while delivering charging power to one or more of these devices over one or more of the data links where the bi-directional communication is carried out, both the bi-directional communication support and the charging power delivery being carried out through a midspan device that will obviate or minimize problems of the type previously described according to aspects of the embodiments.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Further features and advantages of the aspects of the embodiments, as well as the structure and operation of the various embodiments, are described in detail below with reference to the accompanying drawings. It is noted that the aspects of the embodiments are not limited to the specific embodiments described herein. Such embodiments are presented herein for illustrative purposes only. Additional embodiments will be apparent to persons skilled in the relevant art(s) based on the teachings contained herein.

### DISCLOSURE OF INVENTION

In accordance with an aspect, a midspan charging and data communication device (“midspan device”) comprises (a) a first Universal Serial Bus Type-C (USB-C) port that is electrically connectable to a USB-C host device; (b) a second USB-C port that is electrically connectable to a USB-C peripheral device; and (c) USB-C midspan device processor and circuitry electrically connected to the first USB-C port and to the USB-C second port and configured to (1) configure the first USB-C port to support USB data communication in a particular USB data link mode, (2) configure the second USB-C port to support USB data communication in the particular USB data link mode, and (3) at least one of (A) deliver, upon the first USB-C port being further connected to the USB-C host device, power to the USB-C host device as requested by the USB-C host device, the power being delivered from the first USB-C port to the USB-C host device over a first data link between the USB-C host device and the first USB-C port, or (B) deliver, upon the second USB-C port being further connected to the USB-C peripheral device, power to the USB-C peripheral device as requested by the USB-C peripheral device, the power being delivered from the second USB-C port to the USB-C peripheral device over a second data link between the USB-C peripheral device and the USB-C second port.

According to another aspect, a midspan charging and data communication device (“midspan device”) comprises (a) a first USB-C port that is electrically connectable to a USB-C host device; (b) a second USB-C port that is electrically connectable to a USB-C peripheral device; and (c) USB-C midspan device processor and circuitry electrically connected to the USB-C first port and to the USB-C second port and configured to (1) configure the first USB-C port to support bi-directional data communication in a negotiated data link mode, (2) configure the second USB-C port to support bi-directional data communication in the negotiated data link mode, (3) at least one of (A) deliver, upon the first USB-C port being further connected to the USB-C host device, power to the USB-C host device as requested by the USB-C host device, the power being delivered from the first USB-C port to the USB-C host device over a first data link between the USB-C host device and the first USB-C port, the first data link including (i) a first USB-C cable electrically connecting the first USB-C port to the USB-C host device and (ii) the negotiated data link mode, or (B) deliver, upon the second USB-C port being further connected to the USB-C peripheral device, power to the USB-C peripheral device as requested by the USB-C peripheral device, the power being delivered from the second USB-C port to the USB-C peripheral device over a second data link between the USB-C peripheral device and the second USB-C port, the second data link including (i) a second USB-C cable electrically connecting the second USB-C port to the USB-C peripheral device and (ii) the negotiated data link mode.

According to a further aspect, a midspan charging and data communication device (“midspan device”) comprises (a) a first Universal Serial Bus Type-C (USB-C) port that is electrically connectable to a USB-C host device; (b) a second USB-C port that is electrically connectable to a USB-C peripheral device; (c) USB-C midspan device processor and circuitry electrically connected to the first USB-C port and to the USB-C second port and configured to (1) configure the first USB-C port to support bi-directional USB data communication in a particular USB data link mode, the particular data link mode being one of (i) a USB data-only mode or (ii) a USB Alt mode, (2) configure the second USB-C port to support bi-directional USB data communication in the particular USB data link mode, (3) deliver, upon the first USB-C port being further connected to the USB-C host device through a first USB-C cable, power to the USB-C host device as requested by the USB-C host device in accordance with the USB Implementers Forum (USB-IF) specification, the power being delivered from the first USB-C port to the USB-C host device over a first data link between the USB-C host device and the first USB-C port, the first data link including (i) the first USB-C cable and (ii) the particular data link mode, (4) deliver, upon the second USB-C port being further connected to the USB-C peripheral device through a second USB-C cable, power to the USB-C peripheral device as requested by the USB-C peripheral device in accordance with the USB-IF specification, the power being delivered from the second USB-C port to the USB-C peripheral device over a second data link between the USB-C peripheral device and the second USB-C port, the second data link including (i) the second USB-C cable and (ii) the particular data link mode, (d) wherein USB data and Alt mode signals pass between the USB-C host device and the USB-C peripheral device through the USB-C midspan device in the negotiated data link mode upon the first USB-C port being further connected to the USB-C host device and the second USB-C port being further connected to the USB-C peripheral device, such that (1) the USB data and Alt mode signals pass between the USB-C host device and the first USB-C port over the first data link, through the first USB-C port, the USB-C midspan device, and the second USB-C port, and between the second USB-C port and the USB-C peripheral device over the second data link.

### BRIEF DESCRIPTION OF THE DRAWINGS

The above and other objects and features of the embodiments will become apparent and more readily appreciated from the following description of the embodiments with reference to the following figures. Different aspects of the embodiments are illustrated in reference figures of the drawings. It is intended that the embodiments and figures disclosed herein are to be considered to be illustrative rather than limiting. The components in the drawings are not necessarily drawn to scale, emphasis instead being placed upon clearly illustrating the principles of the aspects of the embodiments. In the drawings, like reference numerals designate corresponding parts throughout the several views.

### BRIEF DESCRIPTION OF THE SEVERAL VIEWS OF THE DRAWING

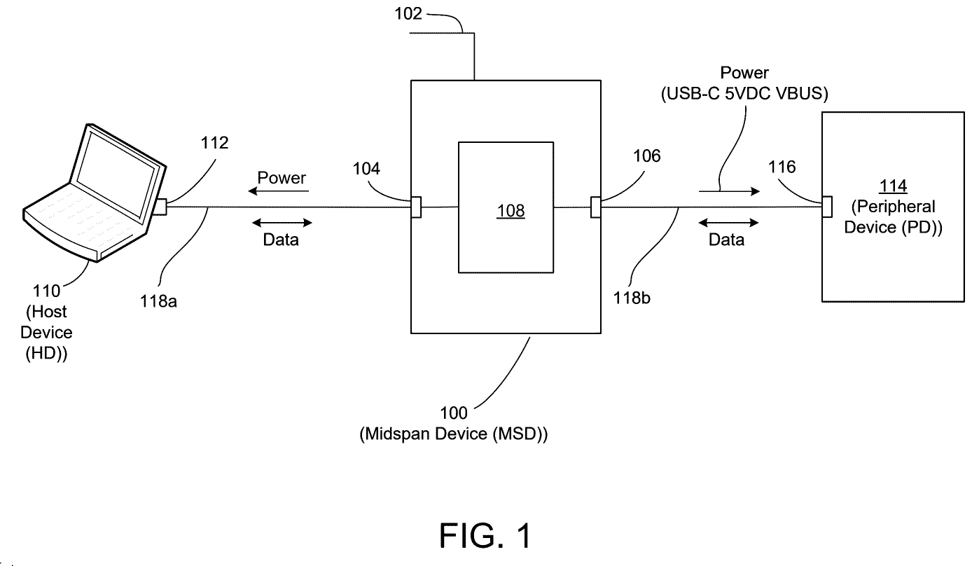

FIG. 1 is a block diagram showing an example of an arrangement incorporating a Universal Serial Bus Type-C (USB-C) midspan device according to an embodiment.

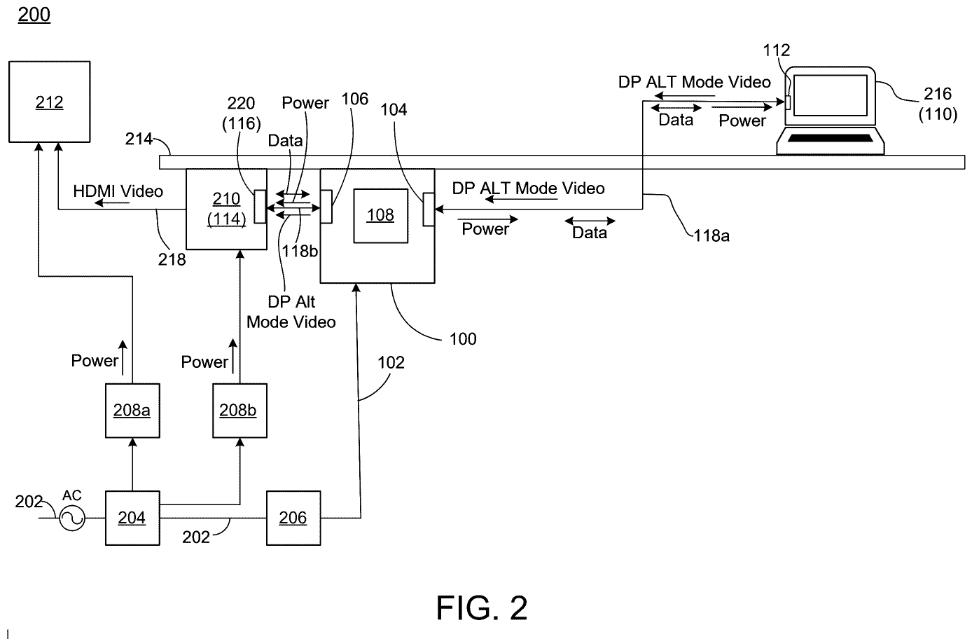

FIG. 2 is a block diagram showing an example of an application of the midspan device of FIG. 1 in a conference room setting.

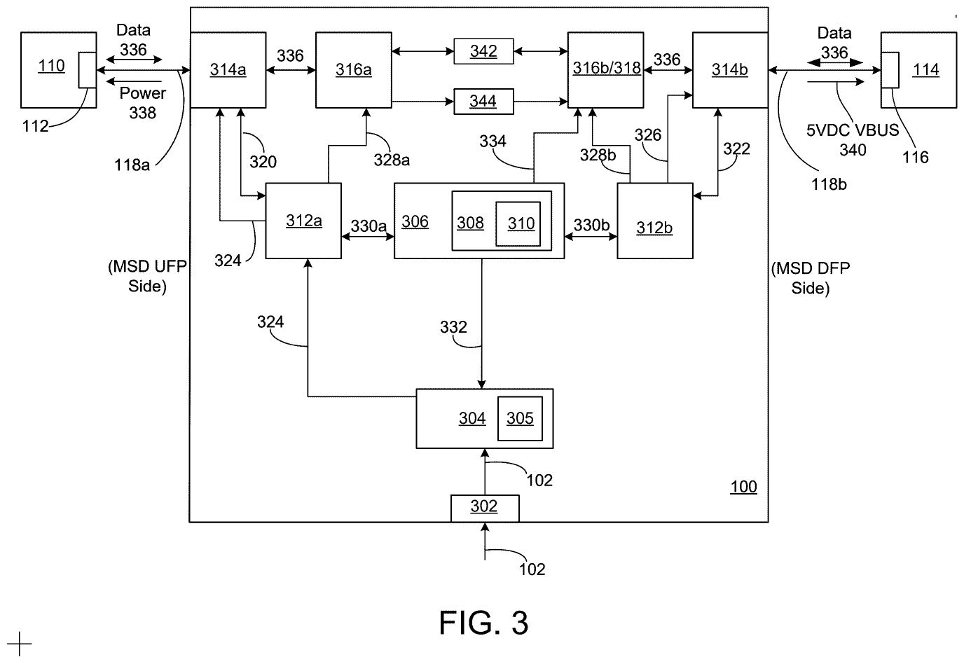

FIG. 3 is a schematic block diagram illustrating the major components of the midspan device of FIG. 1.

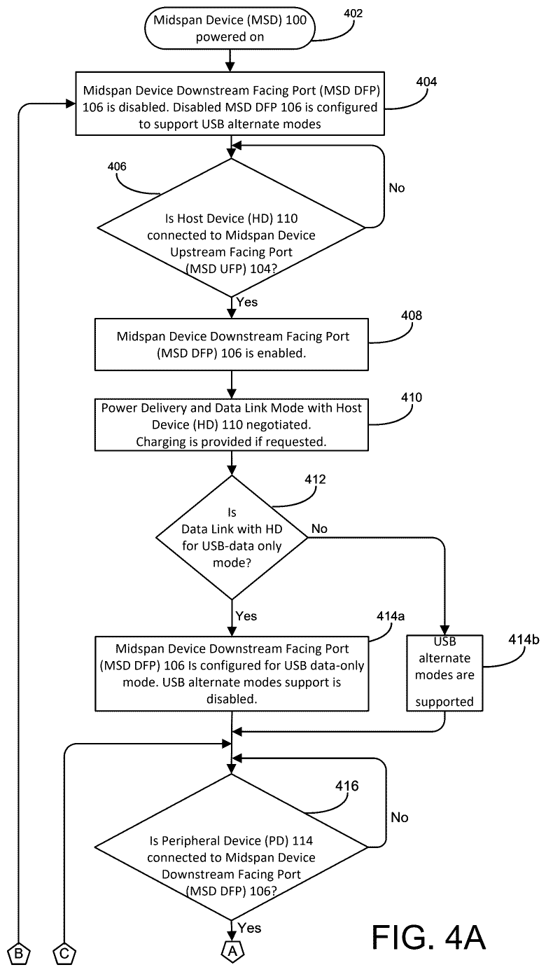

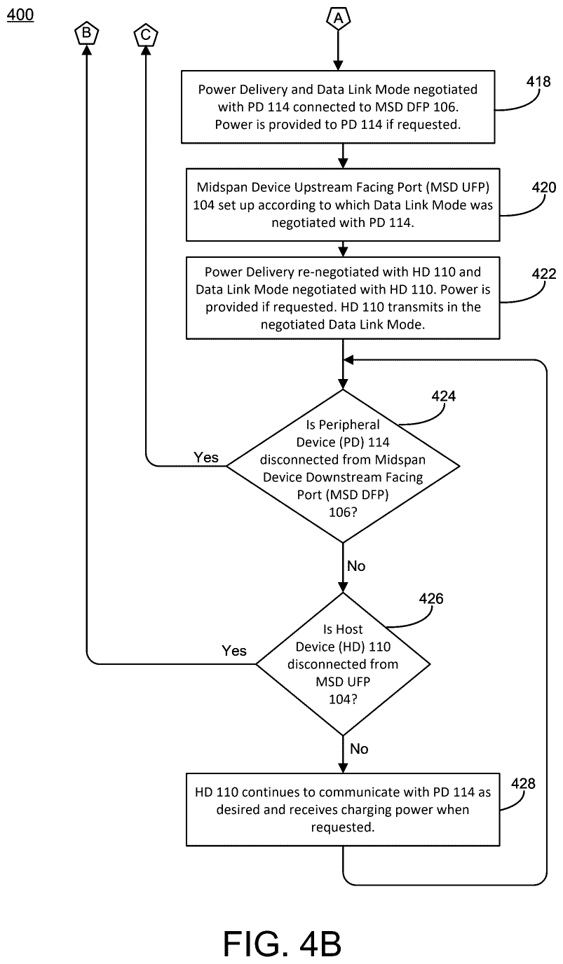

FIG. 4A-4B is a flowchart showing an example of a process for start-up and operation of the midspan device of FIG. 1 according to an embodiment.

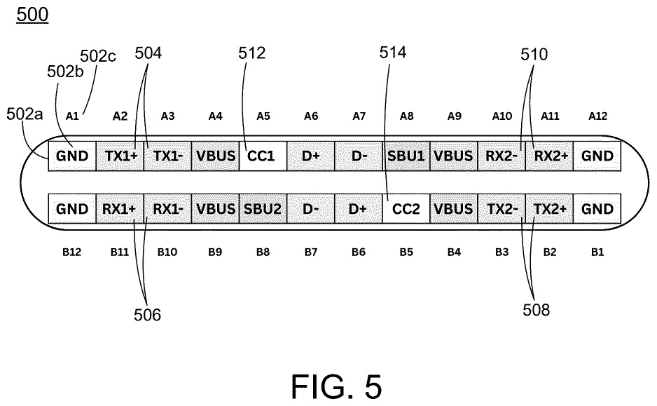

FIG. 5 is a pinout diagram showing a known arrangement of pins in a USB-C plug or receptacle.

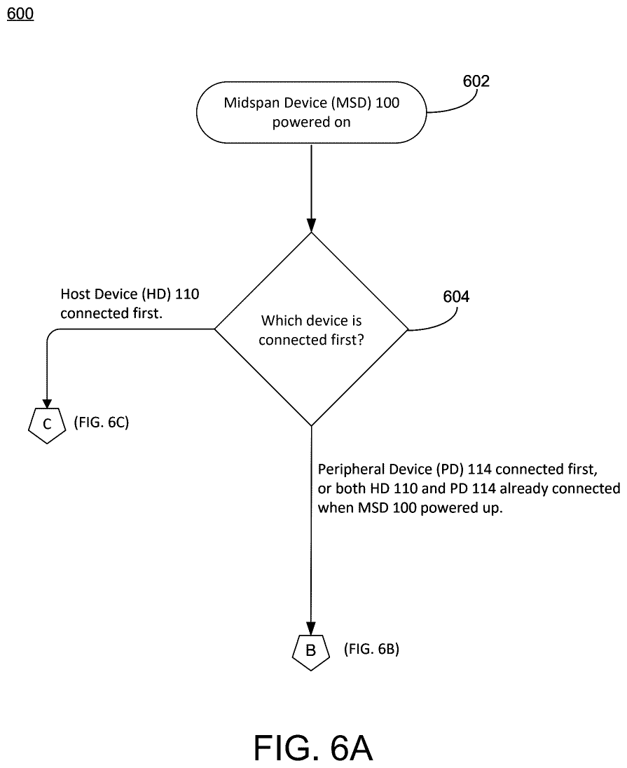

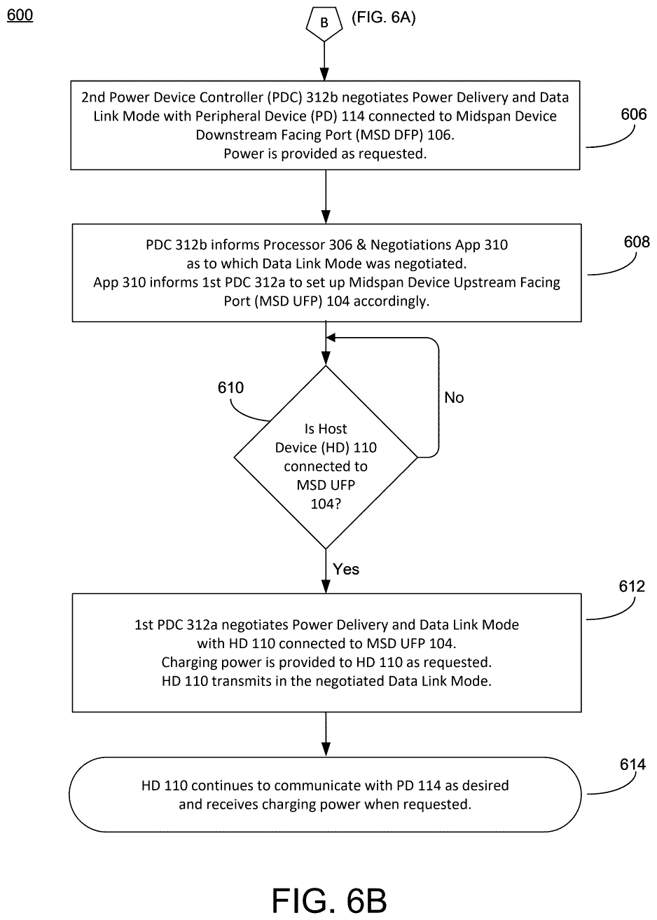

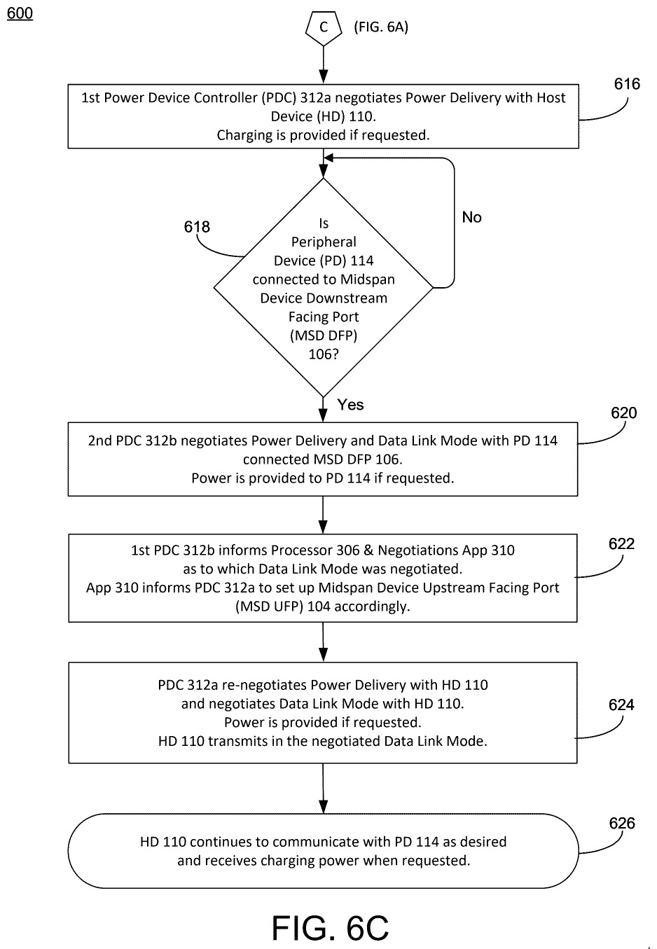

FIG. 6A-6C is a flowchart showing an example of a process for start-up and operation of the midspan device of FIG. 1 according to another embodiment.

Table 1 shows examples of various operating modes of the USB-C midspan device of FIG. 1

### DETAILED DESCRIPTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims. The detailed description that follows is written from the point of view of a company that designs, manufactures, markets, and sells home and business audio-video distribution systems, home and business environmental, lighting, shades, and security systems, and audio-video teleconferencing systems. Therefore, it is to be understood that generally the concepts discussed herein are applicable to various subsystems and not limited to only a particular device or class of devices, such as charging and bidirectional data communication device devices, and more particularly to a USB-C midspan charging and bidirectional data communication device for use with any and all of the above discussed systems. USB-C refers to a Universal Serial Bus Type-C (USB-C) communications protocol.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” or “in an embodiment” in various places throughout the specification is not necessarily referring to the same embodiment. Further, the particular feature, structures, or characteristics may be combined in any suitable manner in one or more embodiments.

### LIST OF REFERENCE NUMBERS FOR THE MAJOR ELEMENTS IN THE DRAWINGS

100 Midspan Universal Serial Bus Type-C (USB-C) Charging and Transceiver Device (Midspan Device, MSD)
102 Direct Current (DC) Power
104 Midspan Device USB-C Upstream Facing Port (MSD UFP)
106 Midspan Device USB-C Downstream Facing Port (MSD DFP)
108 Midspan Device USB-C Data Transceiving, Processing and Power Charging Circuitry (MSD Circuitry)
110 Host Device (Data Provider, Power Sink) (HD)
112 Host Device Downstream Facing Port (HD DFP)
114 Peripheral Device (PD)
116 Peripheral Device Upstream Facing Port (PD UFP)
118a First USB-C Cable
118b Second USB-C Cable
200 Conference Room Display System With Midspan Device, Peripherals and Host Device (Conference Room)
202 120V AC
204 Alternating Current (AC) Power Outlet
206 AC/DC Converter
208a First External Power Supply
208b Second External Power Supply
210 USB-C DisplayPort Alternate (DP Alt) Mode-to-High Definition Multimedia Interface (HDMI) Converter
212 HDMI Capable Display
214 Conference Room Table
216 Laptop Portable Computer (Laptop)
218 HDMI Cable
220 HDMI Converter Upstream Facing Port
302 Power Plug
304 Variable VBUS Power Supply Unit (With Cable Voltage Drop Compensation Circuit 305)
305 Cable Voltage Drop Compensation (CVDC) Circuit
306 Micro-controller (Processor)
308 Processor Internal Memory
310 Midspan Device USB-C Power and Data Communications Negotiations Application (MSD App)
312a First USB-C Power Delivery Controller (PDC)
312b Second USB-C Power Delivery Controller (PDC)
314a First USB-C Receptacle
314b Second USB-C Receptacle
316a First Flip Mux
316b Second Flip Mux
318 USB-C Data Re-timer
320 Upstream Facing Port Configuration Channel Line (UFP CCL)
322 Downstream Facing Port Configuration Channel Line (DFP CCL)
324 Upstream Facing Port Variable VBUS (VV)
326 Downstream Facing Port 5VDC VBUS (5V)
328a First Flip Control Signal
328b Second Flip Control Signal
330a First Power Device Control Signal (I2C Connection)
330b Second Power Device Control Signal (I2C Connection)
332 Voltage Selection and Compensation Signal
334 Re-Driver and Flip Mux Control Signal
336 USB-C Data
338 USB-C Charging Power
340 5VDC VBUS
342 USB Data Re-Driver
344 USB-C Alt-Mode Re-Driver
400 Start-Up Process For Midspan Device
402-428 Steps of Process 400
500 Pinout Diagram Of USB-C Plug or Receptacle
502a Pins
502b Pin Names
502c Pin Numbers
504 TX1 Pins
506 RX1 Pins
508 TX2 Pins
510 RX2 Pins
512 CC1 Pin
514 CC2 Pin

### LIST OF ACRONYMS USED IN THE SPECIFICATION

AC Alternating Current
Alt Mode Alternate Mode
CC Configuration Channel
CCL Configuration Channel Line
CVDC Cable Voltage Drop Compensation
DC Direct Current
DFP Downstream Facing Port
DP DisplayPort™
DRP Dual Role Port
HD Host Device
HDMI® High Definition Multimedia Interface
I/O Input/Output
MHL® Mobile High-Definition Link
MSD Midspan Device
PD Peripheral Device
PDC Power Delivery Controller
PSU Power Supply Unit
SS/SS+ SuperSpeed/SuperSpeed+
UFP Upstream Facing Port
USB-C Universal Serial Bus Type C
VV Variable VBUS

The different aspects of the embodiments described herein pertain to devices, systems, methods, processes, and modes for supporting USB-C bi-directional data and video communication between a USB-C host device and a USB-C peripheral device while delivering charging power to the USB-C host device and/or the USB-C peripheral device over one or more of the data links where the bi-directional data and video communication is supported, the charging power delivery and the bi-directional data and video communication support being through a midspan device according to these aspects of the embodiments, but is not limited thereto except as may be set forth expressly in the appended claims.

Crestron® Electronics Inc. is one of the world's leading manufacturers of control and automation systems, innovating technology to simplify and enhance modern lifestyles and businesses. Crestron® designs, manufactures, and offers for sale integrated solutions to control audio, video, computer, and environmental systems. In addition, the devices and systems offered by Crestron® serve to streamline technology, improving the quality of life in commercial buildings, universities, hotels, hospitals, and homes, among other locations. Accordingly, the devices, systems, methods, processes, and modes for facilitating USB-C bi-directional data and/or video communication between a USB-C host device and a USB-C peripheral device while delivering charging power to the USB-C host device and/or the USB-C peripheral device over one or more of the data links where the bi-directional communication is facilitated, through a midspan device that both delivers the charging power and that facilitates the USB-C bi-directional data and video communications according to aspects of the embodiments, can be used with virtually any two USB-C enabled devices that may be manufactured by Crestron® Electronics Inc.

FIG. 1 is a block diagram showing an arrangement incorporating a Universal Serial Bus Type-C (USB-C) midspan charging and data communication device (USB-C midspan device (MSD)) 100 according to an embodiment.

More specifically, FIG. 1 shows the USB-C midspan device (MSD) 100 connected between a host data providing device, also known as a host device (HD) 110, and a peripheral device (PD) 114. The USB-C midspan device (MSD) 100 can deliver data to and receive data from the host device (HD) 110 via a first USB-C cable 118a as well as deliver charging power to the host device (HD) 110 via the first USB-C cable 118a. The USB-C midspan device (MSD) 100 also delivers data to and receives data from the peripheral device (PD) 114 over a second USB-C cable 118b and can deliver charging power to the peripheral device (PD) 114 over the second USB-C cable 118b.

Conversely, the host device (HD) 110 can transmit or receive data and/or receive charging power via the USB-C midspan device (MSD) 100 over the first USB-C cable 118a, and the peripheral device (PD) 114 can transmit or receive data and/or receive charging power via the USB-C midspan device (MSD) 100 over the second USB-C cable 118b.

The USB-C midspan device (MSD) 100 comprises, at a high-level, midspan device USB-C data transceiving, processing and power charging circuitry (MSD Circuitry) 108. The USB-C midspan device (MSD) 100 also includes a direct current (DC) input 102, a midspan device upstream facing port (MSD UFP) 104, and a midspan device downstream facing port (MSD DFP) 106. The USB-C midspan device (MSD) 100 is connected via the midspan device upstream facing port (MSD UFP) 104 to the first USB-C cable 118a which, in turn, is connected via a host device downstream facing port (HD DFP) 112 to the host device (HD) 110. The USB-C midspan device (MSD) 100 is also connected through the midspan device downstream facing port (MSD DFP) 106 to the second USB-C cable 118b which, in turn, is connected via a peripheral device upstream facing port (PD UFP) 116 to the peripheral device (PD) 114. According to the embodiments, the term “Data” as used in FIG. 1 includes USB 2.0 data packets, USB-C SuperSpeed+ data packets, and video data packets as defined by the USB industry standards, of which the entire contents of each are expressly incorporated herein by reference.

Several terms are now defined for use with regard to the aspects of the embodiments.

Upstream Facing Port (UFP): An upstream facing port (UFP) may be a USB-C port on a device, such as on a USB flash drive, a USB monitor, or a USB mouse. Alternatively, the upstream facing port (UFP) may be an upstream port of a hub that connects to a USB host. As those of skill in the art can appreciate, a USB-C hub is a device that expands the functionality of a USB-C port. Further, as those of skill in the art can appreciate, the upstream facing port (UFP) is often characterized as a power sink. Still further, as those of skill in the art can appreciate, the upstream facing port (UFP) serves as more than a mere connector—it is a functional feature on a device that provides specific capabilities as defined within the USB-C standards.

Downstream Facing Port (DFP): A downstream facing port (DFP) may be a USB-C port that is typically located on a host device, such as on a personal computer (PC), a laptop, a smart device, or the like. Alternatively, the downstream facing port (DFP) may be a USB-C port on a downstream port of a hub to which devices are connected. Furthermore, as those of skill in the art can appreciate, a downstream facing port (DFP) can be characterized as a power source. Still further, as those of skill in the art can appreciate, a downstream facing port (DFP) serves as more than a mere connector—it is a functional feature on a device that provides specific capabilities as defined within the USB-C specifications.

Dual Role Port (DRP): A dual role port (DRP) is a USB-C port that can function as either an upstream facing port (UFP) or a downstream facing port (DFP). The dual role port can switch both power and data roles independently. That is, the dual role port (DRP) can act as an upstream facing port (UFP) that can also deliver power.

Provider/Source Port (PSP): A provider/source port (PSP) is a USB port capable of delivering power over the power conductor bus (VBUS). A USB-C provider/source port (PSP) includes a resistor referred to as an “Rp termination,” that is, a pull-up resistor asserted on the configuration channel line (CC1) of the USB-C cable.

Consumer/Sink Port (CSP): A consumer/sink port (CSP) is a USB-C port capable of “sinking” power from the power conductor (VBUS). A USB-C consumer/sink port (CSP) includes a resistor referred to as an “Rd termination,” that is, a pull-down resistor asserted on the configuration channel line (CC1) of the USB-C cable.

USB SuperSpeed (SS) and SuperSpeed+ (SS+) Modes: USB-C SuperSpeed (SS) mode and SuperSpeed+ (SS+) mode relate to two versions of USB protocols that support different transfer speeds. The USB 3.1 Gen 1x1 protocol (also named USB-C SS mode) supports a 5 Gbps transfer speed, whereas the USB 3.2 Gen 2x1 protocol (also named USB-C SS+ mode) supports a 10 Gbps transfer speed. The USB-C SS and SS+ mode support bi-directional data transfer only.

Mixed Mode: Mixed Mode is a mode of operation of the USB communication protocol that uses two USB-C data lanes for Alt Mode and the two USB-C data lanes for SS/SS+ data communications.

Alternate Modes (Alt Modes): USB Alt modes are a feature of USB-C technology that allows for the transmission of video, audio, and other, non-standard USB, data formats across a USB-C connector. These alternate modes are negotiated over the USB power delivery standard on the connectors configuration channel (CC line). Alt mode negotiation occurs after the initial USB-C connection and power negotiation have been completed. Alt Mode uses the four SuperSpeed differential pairs of a USB-C interface to transmit non-USB data. One such Alt mode, DisplayPort (DP), sends data packets. Depending on the number of DisplayPort (DP) data lanes used, there are typically two modes of DisplayPort Alternate Mode (DP Alt Mode), namely, a 2-data lane mode and a 4-data lane mode. The High-Definition Multimedia Interface (HDMI®), Thunderbolt™, and Mobile High-Definition Link (MHL®) standards are also all supported for video. As those of skill in the art can appreciate, a “USB-C data lane” refers to a single data transmission channel within a USB-C connector, which is essentially one of the four pairs of pins within the USB-C connector that can be used to send and receive data, allowing for faster data transfer speeds when multiple data lanes are utilized together. Essentially, each data lane acts as a dedicated pathway for data flow within the USB-C connection. Within the USB-C connector, two SuperSpeed differential pairs—one pair for transmitting data (Tx) and one pair for receiving data (Rx)—combine to form a USB-C SuperSpeed data lane. With four SuperSpeed differential pairs inside the USB-C connector, the connector is capable of supporting a maximum of two SuperSpeed data lanes, namely, a Tx1 and Rx1 data lane and Tx2 and Rx2 data lane, with each data lane comprising four lines each. FIG. 5 is a diagram 500, known as a pinout diagram, showing the arrangement of the pins in the USB-C connector, that is, a USB-C plug or receptacle. The pinout diagram 500 shows, for each pin 502a, a pin name 502b and a pin number 502c for that pin. Particularly, the pinout diagram 500 shows the location of the pair of Tx1 pins 504, the pair of Rx1 pins 506, the pair of Tx2 pins 508, and the pair of Rx2 pins 510.

Host: A USB-C host is a system or device that connects to multiple USB-C devices, or clients, and initiates communication with these devices or clients. The host controls all data transfers over the USB-C bus while the devices or clients only signal when that device or client requires attention.

Device: A USB-C device, for the purposes of this discussion, will be referred to as a peripheral device. Peripheral devices can include one or more of a keyboard, a mouse, a printer, and the like. Peripheral devices are generally used within a system —a system typically being a collection of electronic devices used to store and transmit data and/or perform communications whether remotely or locally, such as conference room audio video communications, e.g., a unified communications system.

Universal Serial Bus Type-C (USB-C): Although a detailed discussion of universal serial bus type-C (USB-C) is beyond the scope herein, some background information is now provided. USB-C is an industry-standard connector for transmitting both data and charging power on a single cable. The USB-C connector was developed by the USB Implementers Forum (USB-IF), a group of companies that has developed, certified, and shepherded the USB standard. Most USB-C cables and connectors are capable of transmitting data at 10 gigabits per second (10 Gbps), though some cables and connectors can only transmit at a rate of 5 Gbps. The USB-IF includes more than 700 companies in its membership. In addition, an upstream facing port (UFP) is a device-side port that may or may not be charged or powered from a VBUS. At minimum, the upstream facing port (UFP) must have a USB 2.0 Device connection and provide Rd pull-down resistors on the CC pins. A downstream facing port (DFP) is a port on a USB host and delivers charging power. The downstream facing port (DFP) must have two pull-up resistors, or corresponding current sources, on each CC pin. The resistance value of the resistors, which may be, for example, 56 k, 22 k, or 10 k ohms, indicates the port power capability.

USB-C Power Delivery (USB-C PD): USB-C power delivery is a charging technology based on the USB-C standard and is intended to provide much faster charging than standard charging methods. USB-C power delivery is capable of delivering up to 240 W of power along with data over a single USB-C cable and connector. To deliver the right amount of power to a connected device, a USB-C power delivery charger recognizes the device connected to it and negotiates the power required to charge the device as quickly as possible. This negotiation ensures a quick charge without delivering too much power or damaging the device's circuits. A USB-C power delivery (USB-C PD) specification, which was created by the USB-IF, defines how devices can use the USB-C connector to supply power, how these devices are identified and managed, the functions of the USB-C connector pins, and how these pins can be used to provide power at various voltages and currents.

Data Link Mode: USB data link mode allows for data transfer between, for example, a host device and a peripheral device using a standard USB-C connection. The speed of the data transfer depends on the particular USB data link mode used. For example, as described above, the USB-C SS mode supports a 5 Gbps transfer speed whereas the USB-C SS+ mode supports a 10 Gbps transfer speed. Both the USB-C SS and the USB-C SS+ mode support bi-directional data transfer only. Additional USB data link modes known as Alt modes, as described above, allow for the transmission of video, audio, and other data formats over the standard USB-C connection. Included are known Alt modes, such as DisplayPort (DP), HDMI, MHL, Thunderbolt 4, and VirtualLink, as well as future Alt modes.

Data Link: For the purposes of the present application, a data link is defined as the physical connection between two USB-C devices together with the USB data signals that have been negotiated between the two devices for communication between them over the physical connection. The physical connection may be a USB-C cable. Examples of USB-C devices include a host device (HD), a peripheral device (PD), the USB-C midspan device (MSD) or, more specifically, the downstream facing port (DFP) of the USB-C midspan device (MSD) and the upstream facing port (UFP) of the USB-C midspan device (MSD). Examples of the USB-C data signals include the USB data transfer only modes and the USB Alt Modes. Therefore, a data link may be provided, for example, between a host device (HD) and a peripheral device (PD). As another example, a data link may be provided between a host device (HD) and the upstream facing port (UFP) of the USB-C midspan device (MSD). As a further example, a data link may be provided between a peripheral device (PD) and the downstream facing port (DFP) of the USB-C midspan device (MSD). The term “data link” as defined herein, however, does not refer to, and should be distinguished from, the term “data link layer” as commonly used or as defined in the Open System Interconnection (OSI) model or in the Transmission Control Protocol/Internet Protocol (TCP/IP) Architecture Model.

Referring back to FIG. 1, the USB-C midspan device (MSD) 100 is powered by an AC to DC converter (not shown). The AC to DC converter is plugged into a conventional 120 VAC outlet, and an appropriate DC voltage 102 is supplied to USB-C midspan device (MSD) 100.

Further, as described above, the midspan device upstream facing port (MSD UFP) 104 is connected to the host device downstream facing port (HD DFP) 112 through the first USB-C cable 118a. Thus, charging power can be delivered via the USB-C midspan device (MSD) 100 to the host device (HD) 110 according to aspects of the embodiments. Typical voltages that can be delivered via charging include 5 VDC, 9 VDC, 15 VDC and 20 VDC, with a maximum power of 100 Watts. Furthermore, these USB-C voltages are compensated depending on the length of the second USB-C cable 118b, as a USB-C cable can be at most 6 feet long. The USB-C midspan device (MSD) 100 uses voltage compensation to ensure that the USB-C voltages meet specifications even when cable loss is present. According to further aspects of the embodiments, the host device (HD) 110 can also source power, and in such an event the USB-C midspan device (MSD) 100 can request a 5V VBUS from the host device (HD) 110 because the USB-C midspan device (MSD) 100 can also operate as a dual role port (DRP). As described above, a dual role port (DRP) is a USB-C port that can switch between being a power source and a power sink. Further, the USB-C midspan device (MSD) 100 can deliver up to 5 V to the peripheral device (PD) 114 at a maximum of 7.5 W according to aspects of the embodiments.

Several modes of data transfer will now be discussed in connection with the USB-C midspan device (MSD) 100 according to aspects of the embodiments. As those of skill in the art can appreciate, the data transferred can include data files, voice, audio, video, and the like. Data can be transmitted from the host device (HD) 110 through the USB-C midspan device (MSD) 100 to the peripheral device (PD) 114 in any manner described below according to aspects of the embodiments.

According to an aspect of the embodiments, the USB-C midspan device (MSD) 100 can operate in a Video Alt Mode. As described above, the Alt Mode is a mode of operation of the USB communications protocol in which the four SuperSpeed differential pairs of the USB-C interface are used to transmit non-USB data. Here, the USB-C midspan device (MSD) 100 is connected to the host device (HD) 110 using the midspan device upstream facing port (MSD UFP) 104, the first USB-C cable 118a, and the host device downstream facing port (HD DFP) 112. Then, the peripheral device (PD) 114, which is typically here a monitor, may be connected to the USB-C midspan device (MSD) 100 via the midspan device downstream facing port (MSD DFP) 106, the second USB-C cable 118b, and the peripheral device upstream facing port (PD UFP) 116. According to these aspects of the embodiments, the USB-C midspan device (MSD) 100 will deliver USB-C charging power to the host device (HD) 110 and 5 VDC charging power to the peripheral device (PD) 114. The video and USB 2.0 data are permitted to pass from the host device (HD) 110 through the USB-C midspan device (MSD) 100 to the peripheral device (PD) 114 as if no device were present in the middle of the connection, that is, as if the USB-C midspan device (MSD) 100 were not present and the host device (HD) 110 were directly connected via a cable to the monitor. The DP Alt Mode 1.4a (HBR3 ) (8.10 Gbps per data lane) is supported by the USB-C midspan device (MSD) 100 according to aspects of the embodiments.

According to other aspects of the embodiments, the USB-C midspan device (MSD) 100 can operate in a Data-only Mode. As described above, the USB-C midspan device (MSD) 100 is connected to the host device (HD) 110, which is typically a laptop computer or the like, using the midspan device upstream facing port (MSD UFP) 104, the first USB-C cable 118a, and the host device downstream facing port (HD DFP) 112. Then, the peripheral device (PD) 114, which is typically a hard drive, may be connected to the USB-C midspan device (MSD) 100 through the midspan device downstream facing port (MSD DFP) 106, the second USB-C cable 118b, and at the peripheral device upstream facing port (PD UFP) 116. According to such aspects of the embodiments, the USB-C midspan device (MSD) 100 may deliver USB-C charging power to the host device (HD) 110 and 5 VDC charging power to the peripheral device (PD) 114. USB-C SS/SS+ data is allowed to pass from the host device (HD) 110, namely, from the laptop, to the peripheral device (PD) 114, namely, to the hard drive, as if no device were present in the middle of the connection, that is, as if the USB-C midspan device (MSD) 100 were not present and if the laptop were directly connected to the hard drive via a cable.

According to further aspects of the embodiments, the USB-C midspan device (MSD) 100 can also operate in a Mixed Mode (Alt Mode+Data) of operation in which both video and data are transmitted from the host device (HD) 110 over the first USB-C cable 118a to the USB-C midspan device (MSD) 100 and then from the USB-C midspan device (MSD) 100 over the second USB-C cable 118b to the peripheral device (PD) 114.

According to other aspects of the embodiments, the USB 2.0 data can pass from the host device (HD) 110 through the USB-C midspan device (MSD) 100 to the peripheral device (PD) 114. Further, the USB-C midspan device (MSD) 100 can utilize the Billboard Data Function, which is used in Alt mode only, using the USB 2.0 data lines. As those of skill in the art can appreciate, the Billboard Data Function is a feature that informs the host device (HD) 110 about the alternate modes that the peripheral device (PD) 114 supports, thereby preventing silent failures when attempting to use a mode not available on the peripheral device (PD) 114.

Table 1 shows examples of various operating modes of the USB-C midspan device (MSD) 100 of FIG. 1. The Table is a non-limiting summary of the different operating modes according to aspects of the embodiments, including speeds of data transfer, and top-level USB specification identifiers, such as “USB 3.2 Gen2”.

There are a number of key features of the USB-C midspan device (MSD) 100 that are described herein, according to aspects of the embodiments. Such a listing of features, shown below and described in greater detail in the following paragraphs, is not to be taken in a limiting sense, as these and other aspects are included in the inventive embodiments.

According to aspects of the embodiments, the USB-C midspan device (MSD) 100 is “invisible” within a USB-C system. That is, in operation, the USB-C midspan device (MSD) 100 does not appear as a USB hub to the host device or to the peripheral device. Rather, the presence of the USB-C midspan device (MSD) 100 is hidden from both the host device and the peripheral device, and to both the host device and the peripheral device, appears no different than a length of wire would appear at the same location in the circuitry.

According to aspects of the embodiments, the USB-C midspan device (MSD) 100 does not manipulate any of the content sent through it.

According to aspects of the embodiments, the USB-C midspan device (MSD) 100 typically does not store end user data or content, though the USB-C midspan device (MSD) 100 may store such user data or content if desired, and may store such user data or content temporarily, permanently, and/or for a fixed/variable period of time.

According to aspects of the embodiments, the USB-C midspan device (MSD) 100 re-drives and re-times the data being passed through it so that full length USB-C cables can be used on both sides of the USB-C midspan device (MSD) 100, thereby doubling the total length of USB-C cables that may be used.

According to aspects of the embodiments, the USB-C midspan device (MSD) 100 compensates for cable losses due to higher power charging voltage drops.

According to aspects of the embodiments, the USB-C midspan device (MSD) 100 is capable of processing 20 Gbps data transfer rates, among other and higher data transfer rates.

According to aspects of the embodiments, the USB-C midspan device (MSD) 100 is able to implement the Universal Serial Bus 4 (USB4®) specification. As those of skill in the art can appreciate, USB4 is backwards compatible with the USB 3.2 standard, and USB4 devices will provide USB4 Gen 3x2 capability with up to 40 Gbps throughput. The USB-C midspan device (MSD) 100 is capable of facilitating data throughputs at these speeds, among others.

According to aspects of the embodiments, the USB-C midspan device (MSD) 100 is able to use high power AC/DC converters and therefore is capable of supporting higher power USB-C charging voltages and currents. By way of a non-limiting example, an extended power range (EPR) of 240 W or more can be achieved.

According to aspects of the embodiments, the USB-C midspan device (MSD) 100 is capable of transferring Alt mode video in all formats and is not limited to any data rate.

According to aspects of the embodiments, the USB-C midspan device (MSD) 100 is capable of passing USB alternate mode signals between the host device (HD) 110 and the peripheral device (PD) 114. Such USB alternate mode signals include DP Alt mode 4K signals, DP Alt mode 4K and USB 3.2 Gen 1 signals (5 Gbps), and USB 3.2 Gen 2 (10 Gbps) signals.

According to further aspects of the embodiments, multiple midspan device upstream facing ports (MSD UFPs) 104 and multiple midspan device downstream facing ports (MSD DFPs) 106 may be employed. Furthermore, different numbers of midspan device upstream facing ports (MSD UFPs) 104 and midspan device downstream facing ports (MSD DFPs) 106 may be employed. For example, two midspan device upstream facing ports (MSD UFPs) 104 and three midspan device downstream facing ports (MSD DFPs) 106 may be used.

According to aspects of the embodiments, the USB-C midspan device (MSD) 100 negotiates the capabilities of the peripheral device (PD) 114 that is connected to the midspan device downstream facing port (MSD DFP) 106 and can “mimic” (i.e., simulate) these capabilities to the host device (HD) 110 as well as add power delivery negotiation and charging power. The content, which may include data or video, within the USB-C signals received by the USB-C midspan device (MSD) 100 are not processed or manipulated, as discussed above. Instead, the USB-C signals are re-driven and re-timed, thereby “boosting” them in order to increase the transmission length of the first and second USB-C cables 118a and 118b by up to about 100%. According to further aspects of the embodiments, the boosting of the USB-C signals is accomplished while adding USB-C charging for the host device (HD) 110.

According to aspects of the embodiments, the USB-C midspan device (MSD) 100 does not become a hub or USB endpoint, so that substantially any or all USB-C 3.x communications or ALT-Mode capabilities pass through the USB-C midspan device (MSD) 100. According to such aspects of the embodiments, existing and future Alt modes that are supported include, among others, Thunderbolt 3, DisplayPort, HDMI, MHL, and VirtualLink.

According to aspects of the embodiments, the USB-C midspan device (MSD) 100 does not manipulate or transform the content within the received USB-C signals. Rather, the signals are re-driven and re-timed for loss and signal quality. The information and content are not in any way touched or manipulated. Therefore, the audio, video, and data are passed between the downstream facing port (DFP) devices and the upstream facing port (UFP) devices, such as between the host device (HD) 110 and the peripheral device (PD) 114, in the manner the system requires.

According to aspects of the embodiments, the USB-C midspan device (MSD) 100 can deliver USB-C power delivery and charging power to the midspan device upstream facing port (MSD UFP) 104 that would not otherwise be delivered. The data and video communication provided through the USB-C midspan device (MSD) 100 is transparent. The video and data transferred between the host device (HD) 110 and the peripheral device (PD) 114 is the same as if the USB-C midspan device (MSD) 100 were not present.

According to aspects of the embodiments, the USB-C midspan device (MSD) 100 can negotiate the power delivery for both the host device (HD) 110 and the peripheral device (PD) 114 separately. The negotiation includes reading power capabilities from the e-markers of each cable to ensure that cable specifications are not violated.

According to aspects of the embodiments, the voltages supported by the USB-C midspan device (MSD) 100 include 5V, 9V, 15V and 20V for a maximum power level of about 15 W, 27 W, 45 W and 100 W, respectively. Additionally, the USB-C midspan device (MSD) 100 can also support future voltages and power levels including voltages of up to about 28V, 36V, and 48V and power levels of up to about 140 W, 180 W and 240 W, respectively.

According to aspects of the embodiments, the USB-C midspan device (MSD) 100 is capable of measuring voltages and currents to compensate for USB-C cable loss.

According to aspects of the embodiments, the USB-C midspan device (MSD) 100 is not a USB hub. Therefore, the USB-C midspan device (MSD) 100 does not affect the overall system count of USB tiers.

According to aspects of the embodiments, the USB-C midspan device (MSD) 100 is not an endpoint, and hence the USB-C midspan device (MSD) 100 allows data and video to pass through.

According to aspects of the embodiments, the USB-C midspan device (MSD) 100 re-times and re-drives all high-speed signals which are provided the capability of having maximum length USB-C cables on both the midspan device upstream facing port (MSD UFP) 104 and midspan device downstream facing port (MSD DFP) 106 of the USB-C midspan device (MSD) 100. That is, the USB-C midspan device (MSD) 100 essentially acts as a USB-C cable extender.

According to aspects of the embodiments, the USB-C midspan device (MSD) 100 may deliver USB-C data link mode information and power delivery information negotiated between the host device (HD) 110 and the peripheral device (PD) 114 and concurrently be transparent both to the host device (HD) 110 and the peripheral device (PD) 114. Some non-limiting examples of the types of information that can be reported to the end user include whether a USB Alt Mode has been entered, whether the USB Alt Mode is a 2 lane or 4 lane data lane, whether the data rate is 5 Gbps or 10 Gbps for SS(+), the type of charging power that has been requested, the type of charging power that has been delivered, and the cable capabilities that are supported, such as the charging power and data link modes.

According to aspects of the embodiments, the USB-C midspan device (MSD) 100 supports USB-C SS and SS+ data rates of up to 10 Gbps. Also supported are USB4 data rates of up to 40 Gbps.

According to aspects of the embodiments, the USB-C midspan device (MSD) 100 supports USB 2.0 data rates of up to 480 Mbps.

According to aspects of the embodiments, the USB-C midspan device (MSD) 100 supports various video modes including known USB Alt Modes, such as DisplayPort (DP), HDMI, MHL, Thunderbolt 4, and VirtualLink, as well as future Alt modes.

According to aspects of the embodiments, the USB-C midspan device (MSD) 100 supports USB-C SBU protocol.

According to aspects of the embodiments, the USB-C midspan device (MSD) 100 supports USB-C CC protocol.

According to aspects of the embodiments, the USB-C midspan device (MSD) 100 supports maximum cable lengths as defined by USB-IF standards.

According to aspects of the embodiments, the USB-C midspan device (MSD) 100 supports the reading of cable e-markers.

According to aspects of the embodiments, the USB-C midspan device (MSD) 100 supports a VCONN charging power of 5V at 1 W or 5 W.

According to aspects of the embodiments, the USB-C midspan device (MSD) 100 supports lower charging power states for the green initiative. The charging power delivered can be renegotiated to a lower value if either one or both of the host device (HD) 110 and the peripheral device (PD) 114 sides supports these lower charging power values. According to aspects of the embodiments, the determination of how much charging power to deliver can be made automatically based on a time at particular load values, a measured temperature, a time of day, or at a time that a user deems necessary.

According to aspects of the embodiments, the USB-C midspan device (MSD) 100 can manage power delivery to each channel for power budget savings in a multi-channel environment. The power delivered can be renegotiated by the USB-C midspan device (MSD) 100 to a lower value if either the host device (HD) 110, the peripheral device (PD) 114, or both devices support these lower power values.

According to aspects of the embodiments, the USB-C midspan device (MSD) 100 may be multi-channel where all channels are independent with regard to data and video. According to aspects of the embodiments, the USB-C power delivery can be independently managed by the USB-C midspan device (MSD) 100.

FIG. 2 is a block diagram showing an installation of the USB-C midspan device (MSD) 100 of FIG. 1 in a conference room setting, according to aspects of the embodiments.

FIG. 2 is a non-limiting exemplary installation of the USB-C midspan device (MSD) 100. Here, the USB-C midspan device (MSD) 100 is installed in a conference room 200 with a laptop portable computer (“laptop”) 216 as the host device (HD) 110 and a “USB-C DisplayPort Alternate (DP Alt) Mode-to-High Definition Multimedia Interface (HDMI) Converter” (HDMI converter) 210 as the peripheral device (PD) 114, according to aspects of the embodiments. The HDMI converter 210 is connected to a high definition multimedia interface (HDMI) display 212 which may also be considered part of the peripheral device (PD) 114.

In this setting, the laptop 216 provides, for example, USB-C DisplayPort Alternate (DP Alt) mode video to the USB-C midspan device (MSD) 100. The USB-C midspan device (MSD) 100 then provides the USB-C DP Alt mode video to the HDMI converter 210. The USB-C DP Alt mode video data is converted by the HDMI converter 210 into HDMI-compatible video data and then provided to the HDMI display 212.

More specifically, the laptop 216 transmits the USB-C DP Alt mode video along the first USB-C cable 118a, which is connected to the laptop 216 via the host device downstream facing port (HD DFP) 112. The USB-C DP Alt mode video is then received at the USB-C midspan device (MSD) 100, which is connected to the first USB-C cable 118a via the midspan device upstream facing port (MSD UFP) 104. Next, the USB-C DP Alt mode video is re-transmitted by the USB-C midspan device (MSD) 100 along the second USB-C cable 118b, which is connected to the USB-C midspan device (MSD) 100 via the midspan device downstream facing port (MSD DFP) 106. The USB-C DP Alt mode video is then received by the HDMI converter 210 from the second USB-C cable 118b which is connected to the HDMI converter 210 at an HDMI converter upstream facing port (UFP) 220. The HDMI converter 210 may also receive charging power from the USB-C midspan device (MSD) 100 through the second USB-C cable 118b, according to aspects of the embodiments. The HDMI converter 210 then converts the USB-C DP Alt mode video data into the HDMI-compatible video data that can be displayed by the HDMI display 212. The HDMI-compatible video is then transmitted to the HDMI display 212 via an HDMI cable 218 which is connected to the HDMI display 212 and to the HDMI converter 210 at each end using respective HDMI connectors (not shown). The charging power may also be transmitted to the HDMI display 212 via the HDMI cable 218.

Thus, the USB-C DP Alt mode video is transferred substantially seamlessly, that is, with virtually little or no transition loss, from the laptop 216 through the USB-C midspan device (MSD) 100 and then through the USB-C-to-HDMI converter 210 to the HDMI display 212.

Additionally, AC electrical power is supplied by a 120V AC power supply 202 and an electrical outlet 204 to an AC/DC converter 206 which generates DC power 102 for the USB-C midspan device (MSD) 100. The AC power from the 120V AC supply 202 and the outlet 204 is also received by a first external power supply 208a and a second external power supply 208b, respectively. The first external power supply 208a then converts the 120 V AC power to an AC voltage or a DC voltage at a level suitable for use by the HDMI display 212, such as when the HDMI display 212 does not receive charging power from the USB-C midspan device (MSD) 100 through the HDMI converter 210 in the manner described above. Similarly, the second external power supply 208b converts the 120 V AC power to an AC or a DC voltage at a level suitable for use by the HDMI converter 210, such as when the HDMI converter 210 does not receive charging power from the USB-C midspan device (MSD) 100, also as described above.

FIG. 3 is a schematic block diagram showing the major circuit elements which comprise the USB-C midspan device (MSD) 100 of FIGS. 1 and 2, according to aspects of the embodiments. The USB-C midspan device (MSD) 100 comprises one or more of the following circuit elements: a power plug 302 through which DC power 102 is received, a variable VBUS power supply unit (PSU) 304 having a cable voltage compensation circuit 305, a micro-controller (processor) 306 that includes a processor internal memory 308 that stores a midspan device USB-C power and data communications negotiations application (MSD App) 310, first and second USB-C power delivery controllers (PDCs) 312a and 312b, respectively, first and second USB-C receptacles 314a and 314b, respectively, a first flip multiplexer (first flip mux) 316a and 316b, a second flip multiplexer (second flip mux) 316b, a USB-C Data re-timer 318, a USB data re-driver 342, and a USB-C Alt-mode re-driver 344.

It should be noted that FIG. 1, which is a high-level block diagram, depicts the USB-C midspan device (MSD) 100 at a high-level. That is, FIG. 1 shows the USB-C midspan device (MSD) 100 in the form of its high-level elements, namely, the midspan device USB-C data transceiving, processing and power charging circuitry (MSD Circuitry) 108, the midspan device upstream facing port (MSD UFP) 104, and the midspan device downstream facing port (MSD DFP) 106. By contrast, FIG. 3 shows the USB-C midspan device (MSD) 100 as the circuitry elements which comprise the high-level elements of FIG. 1. For example, the midspan device upstream facing port (MSD UFP) 104 is a combination of various circuitry elements, such as the first USB-C receptacle 314a and other circuitry elements shown in FIG. 3, as well as various software and/or firmware, such as the software and/or firmware that resides in the internal memory 308 of the micro-controller (processor) 306. Similarly, the midspan device downstream facing port (MSD DFP) 106 is a combination of various circuitry elements, such as the second USB-C receptacle 314b and other circuitry elements shown in FIG. 3, as well as the various software and/or firmware including that which resides in the internal memory 308 of the micro-controller (processor) 306.

Also, some of the circuitry elements may be combined into a single integrated circuit. For example, the second flip mux 316b and the USB-C data re-timer 318 may be combined into a “second flip mux and USB-C data re-timer 316b/318”, though such integration is not required. As described herein, the second flip mux 316b and the USB-C data re-timer 318 together re-time the signals and orient these signals appropriately over the first and second USB-C cables 118a and 118b. By contrast, the USB data re-driver 342 and the USB-C Alt-mode re-driver 344 are not combined but are shown as separate devices, though both re-drivers perform the same basic function of re-driving signals, because each device carries out this function using a different data protocol. Specifically, the USB data re-driver 342 handles the USB signals, whereas the USB-C Alt-mode re-driver 344 handles the USB alternate mode signals, such as DisplayPort (DP) signals. As another example, the first and second flip muxes 316a and 316b, which orient the signals for the USB-C cables 118a and 118b, respectively, depending on the orientation of each cable, also may not be combined. Separate flip muxes are required because the first and second USB-C cables 118a and 118b are each insertable in one of two orientations. The first and second flip muxes 316a and 316 b adjust the orientation of the signals so that both sides of the connection are informed as to which data lane is carrying which signal. When the signals are in the opposite direction, the flip muxes 316a and 316 b receive the USB-C signals from the USB-C cables 118a and 118b, respectively, and divide their respective USB-C signals into USB 3.2 signals and DisplayPort signals.

As described above, the USB-C midspan device (MSD) 100, according to aspects of the embodiments, also delivers USB-C charging power 338 to the host device (HD) 110, such as in the absence of a local ability to charge the host device (HD) 110. The USB-C midspan device (MSD) 100 uses several integrated circuits (ICs), shown and discussed in greater detail below, including the first and second USB-C power delivery controllers (PDCs) 312a and 312b, the first and second USB-C receptacles 314a and 314b, the first and second flip muxes 316a and 316b, the USB-C data re-timer 318, the USB data re-driver 342, and the USB-C Alt-mode re-driver 344, among others, to facilitate these aspects of the embodiments. Those of skill in the art can appreciate that these ICs are designed to meet USB-C standards. These ICs also control the flow of video, data, and communication protocol signals such as Configuration Channel (CC) and Side Band Use (SBU). SBU functionality is used in audio adapter accessory mode and alternate modes. Such alternate modes includes USB4, DisplayPort, HDMI, MHL and Thunderbolt over the Type-C interface.

According to aspects of the embodiments, the first and second USB-C power delivery controllers (PDCs) 312a and 312b each perform power delivery negotiations between a respective charging device and a respective charged device, that is, between the device delivering the charging power and the device receiving the charging power. Each of the first and second USB-C power delivery controllers (PDCs) 312a and 312b serves as a smart power controller on both the charging device and the charged device to negotiate how much charging power the charging source can supply and how much charging power the charged device can receive. The first and second USB-C power delivery controllers (PDCs) 312a and 312b can also each negotiate data and video links. Further, the first and second USB-C power delivery controllers (PDCs) 312a and 312b can also handle all configuration channel (CC) line communication. The first and second USB-C power delivery controllers (PDCs) 312a and 312b are programmed to implement configuration channel (CC) line communications according to USB-IF specifications. Moreover, the first and second USB-C power delivery controllers (PDCs) 312a and 312b control other functions within the USB-C midspan device (MSD) 100, as described below.

According to aspects of the embodiments, the first and second flip muxes 316a and 316b each orient the data signals on a USB-C connector depending on the orientation of the connector. The first and second flip controls signals 328a and 328b are each controlled by a corresponding one of the first and second USB-C power delivery controllers (PDCs) 312a and 312b by sensing the voltage on a corresponding configuration channel (CC) line.

According to aspects of the embodiments, the USB-C data re-timer 318 can receive a degraded high-speed digital signal, extract the clock signal and the data from that digital signal, and then re-transmit a fresh copy of the original digital signal. The SuperSpeed/SuperSpeed+ (SS/SS+) signals that may be part of the USB-C data signals are high speed signals and may degrade while within the USB-C midspan device (MSD) 100. Therefore, such signals are re-timed by the USB-C re-timer 318.

According to aspects of the embodiments, the USB data re-driver 342 is an analog amplifier that conditions the high frequency signals to boost their signal quality. Furthermore, the USB data re-driver 342 widens signal eye openings, indicating better signal integrity and lower bit error rate, and compensates for line loss, impedance mismatch and other channel effects. The USB data re-driver 342 extends the reach of high-speed interfaces in systems with faster signal frequencies. The SS/SS+signals that can be part of the USB-C data signals are high speed signals and, as a result, can degrade inside the USB-C midspan device (MSD) 100. Therefore, the USB data re-driver 342 is used to boost these signals.

According to aspects of the embodiments, the USB-C Alt-mode re-driver 344 is an analog amplifier that conditions high frequency signals to boost signal quality. The USB-C Alt-mode re-driver 344 widens signal eye openings, indicating a better signal integrity and a lower bit error rate, and compensates for line loss, impedance mismatch, and other channel effects. The USB-C Alt-mode re-driver 344 is used to extend the reach of high-speed interfaces in systems with faster signal frequencies. The USB alternate mode signals, such as DisplayPort (DP) signals, are high speed signals, and thus the signals may degrade inside the USB-C midspan device (MSD) 100. Therefore, the USB alternate mode signals are boosted by the USB-C Alt-mode re-driver 344. This type of physical part is made by various manufacturers.

Several components of the midspan device USB-C data transceiving, processing and power charging circuitry (MSD Circuitry) 108 of FIG. 1 are controlled by the micro-controller (processor) 306 and by the midspan device USB-C power and data communications negotiations application (MSD App) 310. As those of skill in the art can appreciate, the MSD App 310 is stored in the processor internal memory 308, and the micro-controller (processor) 306 performs actions as programmed by the MSD App 310 in a manner described in greater detail herein. The MSD App 310 and the micro-controller (processor) 306 control the first and second USB-C power delivery controllers (PDCs) 312a and 312 b, the first flip mux 316a, the second flip mux and data re-timer 316b/318, the USB data re-driver 342, and the USB-C Alt-mode re-driver 344, which are shown in FIG. 3 and as described herein, through various signals in accordance with aspects of the embodiments. For clarity and brevity, whenever the USB-C midspan device (MSD) 100 is described as performing an action or operation, unless otherwise noted, it should be presumed that the MSD App 310 stored in the processor internal memory 308 and associated with the micro-controller (processor) 306 assists in performing the operation or action described. As those of skill in the art can appreciate, some hardware devices, namely, integrated circuitry and the like, can operate autonomously.

According to aspects of the embodiments, a variable VBUS power supply unit (PSU) 304 is an integrated circuit that regulates VBUS voltage to the desired voltage. The variable VBUS power supply unit (PSU) 304 is controlled by the micro-controller (processor) 306 and the midspan device USB-C power and data communications negotiations application (MSD App) 310 through voltage selection and compensation signal 332 according to aspects of the embodiments, as described in greater detail below.

As described above, the USB-C midspan device (MSD) 100 compensates for cable losses due to higher power charging voltage drops. A cable voltage compensation circuit (CVCC) 305 is located in a feedback path from the voltage output to the variable VBUS power supply unit (PSU) 304. Whenever the output of the variable VBUS power supply unit (PSU) 304 falls below a programmed value, the cable voltage compensation circuit (CVCC) 305 compensates for voltage drops by implementing a pre-defined slope of line function.

Additionally, there are other control/command signal lines generated by the various devices of the midspan device USB-C data transceiving, processing and power charging circuitry (MSD Circuitry) 108 which are described in greater detail below.

An upstream facing port configuration channel line (UFP CCL) 320 interconnects the first USB-C power delivery controller (PDC) 312a with the host device (HD) 110 through the first USB-C receptacle 314a (located on the USB-C midspan device (MSD) upstream facing port side (UFP side)), the first USB-C cable 118a, and the host device downstream facing port (HD DFP) 112. The upstream facing port configuration channel line CCL UFP 320 transmits the signals required to negotiate power delivery required by the host device (HD) 110 and negotiate a data link mode supported by both the USB-C midspan device (MSD) 100 and the host device (HD) 110. The power delivery and data link mode negotiations are carried out in accordance with USB-IF specifications. Within the host device (HD) 110, a further USB-C power delivery controller (PDC) (not shown) is provided that is programmed by the manufacturer of the host device (HD) 110. The first USB-C power delivery controller (PDC) 312a is programmed by the midspan device USB-C power and the data communications negotiations application (MSD App) 310 for the data link mode from the second USB-C power delivery controller (PDC) 312b, adding charging power, according to aspects of the embodiments.

The downstream facing port configuration channel line (DFP CCL) 322 interconnects the second USB-C power delivery controller (PDC) 312b with the peripheral device (PD) 114 through the second USB-C receptacle 314b (located on the USB-C midspan device (MSD) downstream facing port side (DFP side)), the second USB-C cable 118b, and the peripheral device upstream facing port (PD UFP) 116. The downstream facing port configuration channel line (DFP CCL) 322 transmits the signals needed to negotiate power delivery, when required by the peripheral device (PD) 114, and negotiate a data link mode supported by both the USB-C midspan device (MSD) 100 and the peripheral device (PD) 114. The power delivery and data link mode negotiations are carried out in accordance with USB-IF specifications. Within the peripheral device (PD) 114, another USB-C power delivery controller (PDC) is provided (not shown) that is programmed by the manufacturer of the peripheral device (PD) 114. The second USB-C power delivery controller (PDC) 312b is programmed by the midspan device USB-C power and data communications negotiations application (MSD App) 310 to accept any data link mode and allows charging power up to about 7.5 W, according to aspects of the embodiments.

The upstream facing port variable VBUS (VV) 324 is a variable voltage that delivers charging power to the host device (HD) 110 on the upstream facing port side (UFP side) of the USB-C midspan device (MSD) 100, according to aspects of the embodiments. The upstream facing port variable VBUS (VV) 324 originates at a variable VBUS power supply unit 304.

A downstream facing port 5VDC VBUS (5V) 326 is a 5VDC voltage that is typically delivered to any peripheral device (PD) 114 that is connected through the second USB-C receptacle 314b on the downstream facing port side (DFP side) of the USB-C midspan device (MSD) 100.

The first flip control signal 328a originates in the first USB-C power delivery controller (PDC) 312a and indicates the orientation of the first USB-C cable 118a. The first flip control signal 328a is then used to set the appropriate orientation of the first flip mux 316a. This orientation is recognized by the first USB-C power delivery controller (PDC) 312a according to USB-IF specifications.

The first power device control signal 330a originates from the first USB-C power delivery controller (PDC) 312a and, via an I2C connection, informs the micro-controller (processor) 306 and the midspan device USB-C power and data communications negotiations application (MSD App) 310 of the charging power that was requested by the host device (HD) 110. The first USB-C power delivery controller (PDC) 312a obtains this information by negotiating with the host device (HD) 110 via the upstream facing port configuration channel line (UFP CCL) 320 in accordance with the USB-IF specification.

A voltage selection and compensation control signal 332 originates in micro-controller (processor) 306 and the midspan device USB-C power and data communications negotiations application (MSD App) 310 and sets the variable VBUS power supply unit (PSU) 304 to the appropriate voltage as negotiated by the first USB-C power delivery controller (PDC) 312a and the host device (HD) 110. The first USB-C power delivery controller (PDC) 312a obtains this information by negotiating with the host device (HD) 110 via the upstream facing port configuration channel line (UFP CCL) 320 in accordance with the USB-IF specification. The first USB-C power delivery controller (PDC) 312a then informs the MSD App 310 of the negotiated charging power through the first power device control signal 330a.

The re-driver and flip mux control signal 334 originates in the micro-controller (processor) 306 and the midspan device USB-C power and data communications negotiations application (MSD App) 310. The re-driver and flip mux control signal 334 notifies the second flip mux and USB-C data re-timer 316b/318 of both the appropriate USB-C cable orientation and the data link mode as negotiated between the second USB-C power delivery controller (PDC) 312b and the host device (HD) 114. The second USB-C power delivery controller (PDC) 312b obtains this information by negotiating with the HD 114 via the downstream facing port configuration channel line (DFP CCL) 322 in accordance with the USB-IF specifications. The second USB-C power delivery controller (PDC) 312b then informs the MSD App 310 of the negotiated orientation and data link mode through the power device control signal 330b, which is also an I2C connection.

The variable VBUS power supply unit 304 supplies charging power to the host device (HD) 110 via the first USB-C power delivery controller (PDC) 312a, the first USB-C receptacle 314a (on the USB-C midspan device upstream facing port side (UFP side)), the first USB-C cable 118a, and the host device downstream facing port (HD DFP) 112. The charging power delivered is based on the negotiation between the first USB-C power delivery controller (PDC) 312a and the host device (HD) 110 as reported to the midspan device USB-C power and data communications negotiations application (MSD App) 310. The negotiations between the first USB-C power delivery controller (PDC) 312a and the host device (HD) 110 is carried out in accordance with the USB-IF specifications.

Referring back to FIG. 1, according to aspects of the embodiments, the negotiations carried with for the host device (HD) 110 connected to the midspan device USB-C upstream facing port (MSD UFP) 104 are separate from the negotiations carried out with the peripheral device (PD) 114 connected to the midspan device USB-C downstream facing port (MSD DFP) 106.

Also, as discussed above, though only one peripheral device (PD) 114 and only one host device (HD) 110 are shown connected to the USB-C midspan device (MSD) 100, the arrangement shown is only a non-limiting example. Rather, plural HDs 110 and/or plural PDs 114 may be connected to respective upstream facing ports (UFPs) 104 and/or respective downstream facing ports (DFPs) 106, according to aspects of the embodiments. The midspan device USB-C data transceiving, processing and power charging circuitry (MSD Circuitry) 108, and more specifically, the micro-controller (processor) 306 and the midspan device USB-C power and data communications negotiations application (MSD App) 310 shown in FIG. 3, acquire and process the negotiation details that are generated by the midspan device upstream facing port (MSD UFP) 104 and the midspan device downstream facing port (MSD DFP) 106. The micro-controller (processor) 306 and the MSD App 310 then direct the midspan device upstream facing port (MSD UFP) 104 to deliver charging power to the host device (HD) 110 as required. The micro-controller (processor) 306 and the MSD App 310 also direct both the midspan device upstream facing port (MSD UFP) 104 and the midspan device downstream facing port (MSD DFP) 106 to provide USB-C communication between the host device (HD) 110 and the peripheral device (PD) 116 as required, all according to aspects of the embodiments.

According to an aspect of the embodiments, the charging power is delivered from the midspan device upstream facing port (MSD UFP) 104 through the first USB-C cable 118a to the host device (HD) 110 without any involvement of the midspan device downstream facing port (MSD DFP) 106. Also, according to aspects of the embodiments, power delivery negotiations may be carried out between the USB-C midspan device (MSD) 100 and the host device (HD) 110 even when no peripheral device (PD) 114 is connected to the USB-C midspan device (MSD) 100, and charging power is still delivered from the USB-C midspan device (MSD) 100 to any host device (HD) 110 that is connected to a respective midspan device upstream facing port (MSD UFP) 104.

According to aspects of the embodiments, any host devices (HDs) 104 connected to their respective midspan device upstream facing ports (MSD UFPs) 104 are always allowed to charge while, concurrently, any PDs 114 that are connected to their respective midspan device downstream facing ports (MSD DFPs) 106 are able to receive 5VDC VBUS power as needed.

Referring back to FIG. 3, the second USB-C power delivery controller (PDC) 312b interrogates the peripheral device (PD) 114 connected to the second USB-C receptacle 314b (on the USB-C midspan device downstream facing port side (DFP side)), and passes the obtained information on to the micro-controller (processor) 306 and the midspan device USB-C power and data communications negotiations application (MSD App) 310. The obtained information may include the data link mode and the cable orientation. The micro-controller (processor) 306 and the MSD App 310 then use the obtained information to determine the type of information or data to be transferred to the host device (HD) 110, if any. The micro-controller (processor) 306 and the MSD App 310 also use the obtained information to “mimic” the peripheral device (PD) 114 to the host device (HD) 110 connected to the first USB-C receptacle 314a (on the midspan device upstream facing port side (UFP side)). That is, the micro-controller (processor) 306 and the MSD App 310 use the obtained information to simulate, to the host device (HD) 110, the presence of the peripheral device (PD) 114 in a manner that causes the peripheral device (PD) 114 to appear to be directly connected to the host device (HD) 110. As a result of this “mimicry,” the midspan device (MSD) 100, which is actually directly connected to the host device (HD) 110, is hidden from the host device (HD) 110. That is, the midspan device (MSD) 100 is “invisible” to the host device (HD) 110 and appears no different to the peripheral device (PD) 114 than would a cable connecting the host device (HD) 110 to the peripheral device (PD) 114, according to aspects of the embodiments.

The USB-C midspan device (MSD) 100 and the midspan device USB-C power and data communications negotiations application (MSD App) 310 may also transmit messages to the host device (HD) 110 so that the MSD 100 may deliver up to 100 watts (100 W) of charging power, though other amounts of charging power may also be delivered according to other aspects of the embodiments. The micro-controller (processor) 306 and the MSD app 310 may also use the information from the second USB-C power delivery controller (PDC) 312b to set the second flip mux and USB-C data re-timer 316b/318 to the appropriate data link mode and orientation.

According to aspects of the embodiments, the USB-C midspan device (MSD) 100 may also deliver charging power to the peripheral device (PD) 114 connected to the midspan device upstream facing port (MSD DFP) 104. Such peripheral devices (PD) 114 may include a video dongle, a conference phone, a mouse, a KVM switcher, or other types of devices.

According to aspects of the embodiments, the USB-C midspan device (MSD) 100 and the midspan device USB-C power and data communications negotiations application (MSD App) 310 interrogate the attached peripheral devices (PDs) 114 to ascertain their capabilities using the configuration channel (CC) line USB-C negotiation. The MSD 100 then “mimics” (i.e., simulates) these capabilities to the host device (HD) 110 and adds messages so that it is capable of delivering charging power, in this non-limiting case, of up to about 100W.

According to aspects of the embodiments, the USB-C midspan device (MSD) 100 also adds re-driver/reconditioning, via repeater devices, such as the USB-C data re-timer 318, the USB data re-driver 342, and the USB-C Alt-mode re-driver 344, to allow for additional cable length. Typically, a 10 Gbps USB signal can only be carried over cable lengths of up to 1 meter. According to aspects of the embodiments, the USB-C midspan device (MSD) 100 allows the signal to be carried over a first 1 m cable length, such as from the USB-C midspan device (MSD) 100 to the host device (HD) 110 via the midspan device upstream facing port (MSD UFP) 104, and to be carried over another 1 m cable length, such as from the USB-C midspan device (MSD) 100 to the peripheral device (PD) 114 via the midspan device downstream facing port (MSD DFP) 106, thereby doubling the distance that the signal may be carried.

As those of skill in the art can appreciate, some peripheral devices (PDs) 114 use the wires of the USB-C cable for non-USB functions. Such uses are described as operating in an “Alternate-Mode” (Alt-Mode). For example, “DisplayPort” is known Alt-mode. As those of skill in the art can appreciate, the USB-C DisplayPort (DP) Alt Mode leverages the alternate mode functional extension of the USB Type-C interface and shares similar electrical characteristics with USB 3.1, allowing the sharing of common system elements.

When using a USB alternate mode, such as the DisplayPort (DP) Alt-mode, the host device (HD) 110 and the first USB-C power delivery controller (PDC) 312a negotiate communications using the configuration channel (CC) line of the first USB-C cable 118a. The peripheral device (PD) 114 and the second USB-C power delivery controller (PDC) 312b also negotiate communications using the configuration channel (CC) line of the second USB-C cable 118b. According to aspects of the embodiments, the USB-C midspan device (MSD) 100 is able to “understand” these negotiation and participate. The USB-C midspan device (MSD) 100 then sets the direction and drive type of the re-driver circuit, the re-timer circuit and the flip muxes for the negotiated signals using the information obtained in the negotiation between the peripheral device (PD) 114, the host device (HD) 110 and the first and second USB-C power delivery controllers (PDCs) 312a and 312b. According to aspects of the embodiments, the direction and drive type are set for each of the first flip mux 316a, the second flip mux and USB-C data re-timer 316b/318, the USB data re-driver 342, and the USB-C Alt-mode re-driver 344. As each device is a separate device, each device is instructed separately. Similar instructions may be provided for all USB-C devices that can use the DP Alt Mode or another USB alternate mode. The negotiations are not dependent on the re-timer/flip mux being set appropriately. Only the flow of data is.

As noted above, according to aspects of the embodiments, the USB-C midspan device (MSD) 100 is “invisible” within a USB-C system. That is, in operation, the USB-C midspan device (MSD) 100 does not appear as a USB hub to the host device (HD) 110 or to the peripheral device (PD) 114. Rather, the presence of the USB-C midspan device (MSD) 100 is hidden from the host device (HD) 110 and from the peripheral device (PD) 114 and appears no different than a length of wire would appear at the same location in the circuitry.

Specifically, the presence of the USB-C midspan device (MSD) 100 is hidden from the host device (HD) 110 and the peripheral device (PD) 114 using the signaling in the configuration channel (CC) line. Referring back to FIG. 5, the pins 502a of the pinout diagram 150 of the USB-C plug or receptacle include a CC1 pin 512 and a CC2 pin 514. Typically, either the CC1 pin 512 or the CC2 pin 514 is connected to a configuration channel (CC) line within a USB-C device or a USB-C cable. Ordinarily, when two USB-C devices are connected via a USB-C cable, the configuration channel (CC) line that extends from one USB-C device via the USB-C cable to another device is used by each device to detect and manage the connection between the two devices. For example, when a USB-C host device is directly connected to a USB-C peripheral device using a USB-C cable, the USB-C host device and the USB-C peripheral device use the configuration channel (CC) line to detect the presence of the connection between the two devices and the current carrying capability of the connection.

Referring back to FIG. 1-3, as described above, the host device (HD) 110 is connected to the peripheral device (PD) 114 through the USB-C midspan device (MSD) 100. More specifically, the host device (HD) 110 is connected to the peripheral device (PD) 114 through the first USB-C cable 118a, the USB-C midspan device (MSD) 100, and the second USB-C cable 118b. However, according to aspects of the embodiments, no direct communication is carried out between the host device (HD) 110 and the peripheral device (PD) 114 over the configuration channel (CC) line. Though the host device (HD) 110 and the peripheral device (PD) 114 are connected through the USB-C midspan device (MSD) 100, the two devices are not connected over the configuration channel (CC) line. Rather, a first configuration channel (CC) line extends from the host device (HD) 110 over the first USB-C cable 118a to the USB-C midspan device (MSD) 100 but terminates within the USB-C midspan device (MSD) 100, and a second configuration channel (CC) line extends from the USB-C midspan device (MSD) 100 over the second USB-C cable 118b to the peripheral device (PD) 114. Thus, the host device (HD) 110 does not detect, through either configuration channel (CC) line, the presence of the USB-C midspan device (MSD) 100 at the other end of the first USB-C cable 118a. Similarly, the peripheral device (PD) 114 does not detect the presence of the USB-C midspan device (MSD) 100 at the other end of the second USB-C cable 118b through either configuration channel (CC) line.

Moreover, as described above, the USB-C midspan device (MSD) 100 negotiates the capabilities of the peripheral device (PD) 114 that is connected to the midspan device downstream facing port (MSD DFP) 106. and can “mimic” (i.e., simulate) these capabilities to the host device (HD) 110. In accordance with the aspects of the embodiments, the USB-C midspan device (MSD) 100 can use the capabilities of the peripheral device (PD) 114 to “mimic” (i.e., simulate) the presence of the peripheral device (PD) 114 over the first configuration channel (CC) line to the host device (HD) 110. That is, the USB-C midspan device (MSD) 100 communicates with the host device (HD) 110 over the first configuration channel (CC) line as if it were the peripheral device (PD) 114. As a result of this “mimicry,” the peripheral device (PD) 114 appears to the host device (HD) 110 as if it were directly connected to the host device (HD) 110, in place of the USB-C midspan device (MSD) 100 which is actually directly connected to the host device (HD) 110. Thus, the presence of the USB-C midspan device (MSD) 100 is hidden from the host device (HD) 110.

Similarly, the USB-C midspan device (MSD) 100 negotiates the capabilities of the host device (HD) 110 that is connected to the midspan device upstream facing port (MSD UFP) 1046. and can “mimic” (i.e., simulate) these capabilities to the peripheral device (PD) 114. In accordance with the aspects of the embodiments, the USB-C midspan device (MSD) 100 can use the capabilities of the host device (HD) 110 to “mimic” (i.e., simulate) the presence of the host device (HD) 110 over the second configuration channel (CC) line to the peripheral device (PD) 114. That is, the USB-C midspan device (MSD) 100 communicates with the peripheral device (PD) 114 over the second configuration channel (CC) line as if it were the host device (HD) 110. As a result of this “mimicry,” the host device (HD) 110 appears to the peripheral device (PD) 114 as if it were directly connected to the peripheral device (PD) 114, in place of the USB-C midspan device (MSD) 100 which is actually directly connected to the peripheral device (PD) 114. Thus, the presence of the USB-C midspan device (MSD) 100 is hidden from the peripheral device (PD) 114.

Thus, the USB-C midspan device (MSD) 100 seems “invisible” to both the host device (HD) 110 and the peripheral device (PD) 114. Its presence is hidden from both devices, and it appears no different within the circuitry than a length of wire would be at the same location.

The USB-C midspan device (MSD) 100 is capable of delivering charging power to the host device (HD) 110 via the first USB-C cable 118a and to the peripheral device (PD) 114 via the second USB-C cable 118b.

According to further aspects of the embodiments, the USB-C midspan device (MSD) 100 can also interface with other types of devices and provide further signal conditioning to allow for maximum length USB-C cables to be used on both sides of the USB-C midspan device (MSD) 100.

FIG. 4A-4B are a flowchart showing a process 400 for starting up and operating the USB-C midspan device (MSD) 100 shown in FIG. 1-3 according to aspects of the embodiments. As those of skill in the art can appreciate, and as described in greater detail below, the micro-controller (processor) 306, the processor internal memory 308 or other memory devices, and various software and/or firmware that may reside in the processor internal memory 308 or the other memory devices, may be used to implement the process 400 for starting up and operating the USB-C midspan device (MSD) 100. Such implementing includes bi-directionally passing USB data, video, and/or audio, delivering charging power to the host device (HD) 110 over the data link to the host device (HD) 110, and/or delivering charging power to the peripheral device (PD) 114 over the data link to the peripheral device (PD) 114, as well as other features described herein, according to aspects of the embodiments.

First, as shown at step 402, the USB-C midspan device (MSD) 100 is powered on.

Then, as step 404 shows, the midspan device USB-C downstream facing port (MSD DFP) 106 is disabled. The disabling of the midspan device USB-C downstream facing port (MSD DFP) 106 may be carried out under the control of the micro-controller (processor) 306 through the second USB-C power delivery controller (PDC) 312b and the second power device control signal 330b, an I2C connection, by executing firmware or software instructions that reside in the processor internal memory 308.

The disabled midspan device USB-C downstream facing port (MSD DFP) 106 may then be configured to support one or more of the USB Alt Modes, such as by the micro-controller (processor) 306 carrying out further firmware or software instructions that reside in the processor internal memory 308.

Next, as shown at step 406, a determination is made as to whether the host device (HD) 110 is connected to the midspan device USB-C upstream facing port (MSD UFP) 104. Such a determination may be made, for example, by the micro-controller (processor) 306 using the firmware or software that resides in the processor internal memory 308 and through the first USB-C power delivery controller (PDC) 312a which recognizes that the host device (HD) 110 is connected when the first USB-C cable 118 is connected to the midspan device upstream facing port (MSD UFP) 104. If the host device (HD) 110 is not connected to the midspan device USB-C upstream facing port (MSD UFP) 104, then the process 400 “waits” until the host device (HD) 110 device is connected. Namely, the process 400 loops from step 406 along the “No” path back to step 406, and repeats.

Alternatively, upon a determination being made at step 406 that the host device (HD) 110 is connected to the midspan device upstream facing port (MSD UFP) 104, the process 400 proceeds along the “Yes” path to step 408. Then, the midspan device USB-C downstream facing port (MSD DFP) 106, which was disabled at step 404, is again enabled. This enabling may similarly be carried out under the control of the micro-controller (processor) 306 through the second USB-C power delivery controller (PDC) 312b and the second power device control signal 330b, an I2C connection, by executing firmware or software instructions that reside in the processor internal memory 308.

Then, as shown at step 410, the power delivery and the appropriate data link mode with the host device (HD) 110 are negotiated. Such negotiations are carried out under the control of the micro-controller (processor) 306 by executing firmware or software instructions that reside in the processor internal memory 308 and may be carried out through the first USB-C power delivery controller (PDC) 312a and the first power device control signal 330a, an I2C connection.

Charging power may then be delivered to the host device (HD) 110 if such power is requested by the host device (HD) 110 and is based on the power delivery negotiations.

Next, as step 412 shows, a determination is made as to whether the data link mode that was negotiated with the host device (HD) 110 at step 410 is a mode that supports only communication of USB data, namely a USB-data only mode, or whether the negotiated data link mode also supports one or more of the USB alternate modes (Alt modes) described previously. Upon a determination that the negotiated data link mode is a USB-data only mode, the process 400 proceeds along the “Yes” path to step 414a. At step 414a, the midspan device USB-C downstream facing port (MSD DFP) 106 is then configured to support only the USB data-only mode.

Alternatively, when a determination is made that the negotiated data link mode also supports one or more of the USB Alt modes, the process 400 proceeds along the “No” path to step 414b. Then the midspan device USB-C downstream facing port (MSD DFP) 106 is configured to support one or more of the USB Alt modes.

Next, as shown at step 416, a determination is made as to whether the peripheral device (PD) 114 is connected to the USB-C midspan device downstream facing port (MSD DFP) 106. If the peripheral device (PD) 114 is determined not to be connected to the USB-C midspan device downstream facing port (MSD DFP) 106, then the process 400 “waits” until such peripheral device (PD) 114 is connected. Namely, the process 400 loops from step 416 along the “No” path back to step 416. According to aspects of the embodiments, the determination of the connection between the USB-C midspan device (MSD) 100 and the peripheral device (PD) 114 may occur through the operation of the second USB-C power delivery controller (PDC) 312b under the control of the micro-controller (processor) 306 using the firmware or software that resides in the processor internal memory 308.

Alternatively, upon a determination at step 416 that the peripheral device (PD) 114 is connected to the midspan device downstream facing port (MSD DFP) 106, the process 400 proceeds along the “Yes” path to step 418 in FIG. 4B. As step 418 shows, the power delivery and the appropriate data link mode are then negotiated with the peripheral device (PD) 114 that is connected to the midspan device downstream facing port (MSD DFP) 106. More specifically, the micro-controller (processor) 306 negotiates the power delivery and the appropriate data link mode with the peripheral device (PD) 114 through the second USB-C power delivery controller (PDC) 312b and over the downstream facing port configuration channel line (DFP CCL) 322 using the firmware or software that resides in the processor internal memory 308.

Charging power may then be delivered to the peripheral device (PD) 114 if such power is requested by the peripheral device (PD) 114 and is based on the power delivery negotiations with the peripheral device (PD) 114.

Next, as shown at step 420, the midspan device upstream facing port (MSD UFP) 104, which is connected to the host device (HD) 110, is set up to communicate in the same data link mode that was negotiated with the peripheral device (PD) 114. That is, the midspan device upstream facing port (MSD UFP) 104 is set up to transmit and/or receive USB data in this negotiated data link mode.

Then, as step 422 shows, the power delivery is re-negotiated with the host device (HD) 110. The charging power can then be delivered to the host device (HD) 110 as necessary and requested or as required. Also, the data link mode is negotiated with the host device (HD) 110. Typically, the micro-controller (processor) 306 negotiates with the (HD) 110 to transmit and receive in the same data link mode that negotiated with the peripheral device (PD) 114. Thus, the host device (HD) 110 is able to communicate with the peripheral device (PD) 114 in this negotiated data link mode.

Next, as shown at step 424, a determination is made as to whether the peripheral device (PD) 114 is disconnected from the USB-C midspan device downstream facing port (MSD DFP) 106. Such a determination may be carried out in a manner similar to that described in connection with step 416 in FIG. 4A.

If the peripheral device (PD) 114 is determined to be disconnected from the USB-C midspan device downstream facing port (MSD DFP) 106, then the process 400 proceeds along the “Yes” path and returns to step 416 in FIG. 4A where the process 400 again “waits” until such peripheral device (PD) 114 is connected to the USB-C midspan device downstream facing port (MSD DFP) 106.

Alternatively, if the peripheral device (PD) 114 is determined to be connected to the USB-C midspan device downstream facing port (MSD DFP) 106, then the process proceeds along the “No” path and continues to step 426.

As step 426 shows, a determination is now made as to whether the host device (HD) 110 is disconnected from the midspan device USB-C upstream facing port (MSD UFP) 104. Such a determination may be carried out in a manner similar to that described in connection with step 406 in FIG. 4A.

If the host device (HD) 110 is determined to be disconnected from the midspan device USB-C upstream facing port (MSD UFP) 104, then the process 400 proceeds along the “Yes” path and returns to step 406 in FIG. 4A where the process 400 again “waits” until such host device (HD) 110 is again connected to the midspan device USB-C upstream facing port (MSD UFP) 104. Alternatively, if the host device (HD) 110 is determined to be connected to the midspan device USB-C upstream facing port (MSD UFP) 104, then the process proceeds along the “No” path and continues to step 428.

As step 428 shows, the host device (HD) 110 continues to carry out bi-directional communication with the peripheral device (PD) 114 as needed. The bi-directional communication is carried over a data link between the host device (HD) 110 and the midspan device USB-C upstream facing port (MSD UFP) 104, through the midspan device (MSD) 100, and then over a further data link between the USB-C midspan device downstream facing port (MSD DFP) 106 and the peripheral device (PD) 114. The bi-directional communication may be carried out in a data link mode that is USB-data only or in a data link mode that is a USB Alt mode.

Moreover, the host device (HD) 110 receives charging power from the midspan device (MSD) 100 as requested by the host device (HD) 110. The charging power is provided over the same data link between the host device (HD) 110 and the midspan device USB-C upstream facing port (MSD UFP) 104 over which the bi-directional communication is carried. Similarly, the peripheral device (PD) 114 may receive charging power from the midspan device (MSD) 100 as requested by the peripheral device (PD) 114. The charging power is provided over the same data link between the USB-C midspan device downstream facing port (MSD DFP) 106 and the peripheral device (PD) 114 over which the bi-directional communication is transmitted.

Thereafter, the process 400 loops back to step 424 and a determination is again made as to whether the peripheral device (PD) 114 is disconnected from the USB-C midspan device downstream facing port (MSD DFP) 106.

As described above, a start-up and operating process is discussed in reference to FIG. 4A-4B. The process is not meant to limit the aspects of the embodiments, or to suggest that the aspects of the embodiments should be implemented following the start-up process. The purpose of the above process is to facilitate the understanding of one or more aspects of the embodiments and to provide the reader with one or many possible implementations of the processes discussed herein. FIG. 4A-4B illustrates a flowchart of various steps performed during the process. The steps of FIG. 4A-4B are not intended to completely describe the process but only to illustrate some of the aspects discussed above.

FIG. 6A-6C are a flowchart showing an alternative process 600 for starting up and operating the USB-C midspan device (MSD) 100 shown in FIG. 1-3 according to other aspects of the embodiments. As those of skill in the art can appreciate, and as described in greater detail below in connection with FIG. 3, the micro-controller (processor) 306, together with the processor internal memory 308 or another memory device, as well as the MSD USB-C power and data communications negotiations application (MSD App) 310 or other software and/or firmware that may reside in the processor internal memory 308 or other memory device, may be used to implement the process 600 for performing the functions of the USB-C midspan device (MSD) 100 including bi-directionally passing USB data, delivering charging power to the host device (HD) 110, and delivering charging power to the peripheral device (PD) 114, as well as other features described herein, according to other aspects of the embodiments.

First, as shown at step 602, the USB-C midspan device (MSD) 100 is powered on.

Next, as step 604 shows, the USB-C midspan device (MSD) 100 determines which device was first connected to the MSD 100. That is, the USB-C midspan device (MSD) 100 determines whether (a) the host device (HD) 110 was first connected to the midspan device (MSD) 100, (b) the peripheral device (PD) 114 was first connected to the midspan device (MSD) 100, or (c) both the host device (HD) 110 and the peripheral device (PD) 114 were connected to the midspan device (MSD) 100 at the time that the midspan device (MSD) 100 was turned on. It should be noted that the peripheral device (PD) 114 being connected first, namely (b), is equivalent to the host device (HD) 110 and the peripheral device (PD) 114 both being connected at the time when the midspan device (MSD) 100 was turned on, namely (c). The reason that (b) is equivalent to (c) is that for both (b) and (c), the peripheral device (PD) 114 is connected to the midspan device (MSD) 100. Thus, in both (b) and (c), the peripheral device (PD) 114 is available to negotiate power delivery first with the midspan device (MSD) 100.

Therefore, if the USB-C midspan device (MSD) 100 determines that the peripheral device (PD) 114 is connected to the USB-C midspan device (MSD 100 first through the downstream facing port (DFP) 106, or if the USB-C midspan device (MSD) 100 determines that both the host device (HD) 110 and the peripheral device (PD) 114 were connected to the USB-C midspan device (MSD) 100 when the USB-C midspan device (MSD) 100 was powered up, the process 600 proceeds to (B), namely step 606 on FIG. 6B. Alternatively, if the USB-C midspan device (MSD) 100 determines that the host device (HD) 110 is connected to the USB-C midspan device (MSD) 100 first, through the midspan device upstream facing port (MSD UFP) 104, the process 600 proceeds to (C), that is, step 616 on FIG. 6C.

Referring now to FIG. 6B, as shown at step 606, the USB-C midspan device (MSD) 100 negotiates the power delivery and the appropriate data link mode with the peripheral device (PD) 114. More specifically, the second USB-C power delivery controller (PDC) 312b of the USB-C midspan device (MSD) 100 negotiates the power delivery and the appropriate data link mode with the peripheral device (PD) 114 over the downstream facing port configuration channel line (DFP CCL) 322. The second USB-C power delivery controller (PDC) 312b then sets up the midspan device downstream facing port (MSD DFP) 106 to transmit and/or receive USB data in the determined data link mode. The second USB-C power delivery controller (PDC) 312b also delivers charging power to the peripheral device (PD) 114 as requested, in accordance with the USB-IF specification. Based on the negotiation with the peripheral device (PD) 114, the second USB-C power delivery controller (PDC) 312b communicates with the second flip mux and USB-C data re-timer 316b/318, via the re-driver and flip mux control signal 334, to set the appropriate data link mode as well as via the flip control signal 328b to set the orientation.

Then, at step 608, the second USB-C power delivery controller (PDC) 312b passes the information regarding the negotiated data link mode, as determined in step 606, to the micro-controller (processor) 306 and to the MSD USB-C power and data communications negotiations application (MSD App) 310. The second USB-C power delivery controller (PDC) 312b conveys this information to the MSD App 310 via an I2C connection 330b. The MSD App 310 then conveys this information to the first USB-C power delivery controller (PDC) 312a. The first USB-C power delivery controller (PDC) 312a then sets up the midspan device upstream facing port (MSD UFP) 104 to transmit and/or receive the USB data in the negotiated data link mode as well as to deliver charging power as requested. Establishing the appropriate data link mode is handled by the first USB-C power delivery controller (PDC) 312a according to the USB-IF specification. The MSD App 310 conveys this information to the first USB-C power delivery controller (PDC) 312a via another I2C connection 330a.

Next, at step 610 shows, a determination is made as to whether the host device (HD) 110 is connected to the USB-C midspan device (MSD) 100 via the midspan device upstream facing port (MSD UFP) 104. If the host device (HD) 110 is not connected to the USB-C midspan device (MSD) 100, then the USB-C midspan device (MSD) 100 waits until such host device (HD) 110 device is connected. Namely, the process 600 loops from step 610 along the “No” path back to step 610. Alternatively, upon a determination in step 610 that the host device (HD) 110 is connected to the USB-C midspan device (MSD) 100 via the midspan device upstream facing port (MSD UFP) 104, the process 600 proceeds along the “Yes” path to step 612. Such a determination may be made, for example, by the first USB-C power delivery controller (PDC) 312a which recognizes that the host device (HD) 110 is connected when the first USB-C cable 118 is connected to the midspan device upstream facing port (MSD UFP) 104.

As step 612 shows, the first USB-C power delivery controller (PDC) 312a negotiates the power delivery and the appropriate data link mode with the host device (HD) 110. The first USB-C power delivery controller (PDC) 312a negotiates with the host device (HD) 110 over the upstream facing port configuration channel line (UFP CCL) 320 that is between the first USB-C power delivery controller (PDC) 312a and the host device (HD) 110. As described above regarding step 608, the first USB-C power delivery controller (PDC) 312a uses the information that it received from the MSD USB-C power and data communications negotiations application (MSD App) 310 when negotiating with the host device (HD) 110, namely, the information regarding the data link mode negotiated between the second USB-C power delivery controller (PDC) 312b and the peripheral device (PD) 114. Therefore, the first USB-C power delivery controller (PDC) 312a negotiates with the host device (HD) 110 for the host device (HD) 110 to communicate using the same the data link mode as was negotiated with the peripheral device (PD) 114. [Is this last sentence correct?] The first USB-C power delivery controller (PDC) 312a also communicates with the first flip mux 316a, via the first flip control signal 328a, to set the appropriate orientation based on the negotiation with the host device (HD) 110. The host device (HD) 110 is then able to transmit and/or receive data in the negotiated data link mode.

Thereafter, as step 614 shows, the USB-C midspan device (MSD) 100, the host device (HD) 110 and the peripheral device (PD) 114 communicate substantially seamlessly in the negotiated data link mode, according to aspects of the embodiments. The host device (HD) 110 and the peripheral device (PD) 114, according to further aspects of the embodiments, communicate through the USB-C midspan device (MSD) 100 as if the USB-C midspan device (MSD) 100 was not present and as if the two devices were merely connected via a cable. That is, the USB-C midspan device (MSD) 100 is “invisible” to both the host device (HD) 110 and the peripheral device (PD) 114. Also, both the host device (HD) 110 and the peripheral device (PD) 114 are able to receive power from the USB-C midspan device (MSD) 100 as required and/or requested, also according to aspects of the embodiments.

Referring back to FIG. 6A, at step 604, if the host device (HD) 110 is alternatively connected first to the USB-C midspan device (MSD) 100, the process 600 instead proceeds to (C), namely, step 616 in FIG. 6C.

As shown at step 616, the USB-C midspan device (MSD) 100 negotiates power delivery with the host device (HD) 110. More specifically, the first USB-C power delivery controller (PDC) 312a negotiates the power delivery with the host device (HD) 110 over the upstream facing port configuration channel line (UFP CCL) 320 in accordance with the USB-IF specification. The first USB-C power delivery controller (PDC) 312a then sets up the midspan device upstream facing port (MSD UFP) 104 to deliver the charging power to the host device (HD) 110 as requested. The first USB-C power delivery controller (PDC) 312a also communicates with the first flip mux 316a to set the appropriate orientation, via the flip control signal 328a, based on this negotiation with the host device (HD) 110.

Next, at step 618, a determination is made as to whether the peripheral device (PD) 114 is connected to the USB-C midspan device (MSD) 100 via the USB-C midspan device downstream facing port (MSD DFP) 106. If the peripheral device (PD) 114 is determined not to be connected to the USB-C midspan device (MSD) 100, then the USB-C midspan device (MSD) 100 waits until such peripheral device (PD) 114 is connected. Namely, the process 600 loops from step 618 along the “No” path back to step 618. Alternatively, upon a determination at step 618 that the peripheral device (PD) 114 is connected to the USB-C midspan device (MSD) 100 via the midspan device downstream facing port (MSD DFP) 106, the process 600 proceeds along the “Yes” path to step 620. According to aspects of the embodiments, the determination of the connection between the USB-C midspan device (MSD) 100 and the peripheral device (PD) 114 may occur through the operation of the second USB-C power delivery controller (PDC) 312b, as described above.

Then, as step 620 shows, the second USB-C power delivery controller (PDC) 312b negotiates the power delivery and the appropriate data link mode with the peripheral device (PD) 114. More specifically, the second USB-C power delivery controller (PDC) 312b of the USB-C midspan device (MSD) 100 negotiates the power delivery and negotiates the appropriate data link mode with the peripheral device (PD) 114 over the downstream facing port configuration channel line (DFP CCL) 322. The second USB-C power delivery controller (PDC) 312b then sets up the midspan device downstream facing port (MSD DFP) 106 to transmit and/or receive USB data in the determined data link mode, as well as to deliver the power as requested. The peripheral device (PD) 114 may also then transmit and/or receive data in the negotiated data link mode. As described above, and according to aspects of the embodiments, the power delivery negotiation is handled by the second USB-C power delivery controller (PDC) 312b according to the USB-IF specification. Based on the negotiation with the peripheral device (PD) 114, the second USB-C power delivery controller (PDC) 312b also communicates with the second flip mux and USB-C data re-timer 316b/318, via the re-timer and flip mux control 334, to set the appropriate data link mode as well as, via the flip control signal 328b, to set the orientation.

Next, as shown at step 622, the second USB-C power delivery controller (PDC) 312b passes the information regarding the appropriate data link mode, as determined in step 620, to the MSD USB-C power and data communications negotiations application (MSD App) 310. The MSD App 310 then conveys this information to the first USB-C power delivery controller (PDC) 312a so that an appropriate data link mode can be negotiated with the host device (HD) 110 which is connected to the midspan device upstream facing port (MSD UFP) 104. The first USB-C power delivery controller (PDC) 312a then negotiates with the host device (HD) 110 over the upstream facing port configuration channel line (UFP CCL) 320. The first USB-C power delivery controller (PDC) 312a also sets up the midspan device upstream facing port (MSD UFP) 104 to transmit and/or receive USB data in the negotiated data link mode. The second USB-C power delivery controller (PDC) 312b conveys information regarding the negotiated data link mode to the MSD App 310 via the I2C connection 330b. The MSD App 310 then conveys this information to the first USB-C power delivery controller (PDC) 312a via the I2C connection 330a.

Next, at step 624, the USB-C midspan device (MSD) 100 and the first USB-C power delivery controller (PDC) 312a renegotiate power delivery with the host device (HD) 110, and charging power can then be delivered to the host device (HD) 110 as necessary and requested or as required. As described above regarding step 622, the first USB-C power delivery controller (PDC) 312a uses the information that it received from the MSD USB-C power and data communications negotiations application (MSD App) 310 when negotiating with the (HD) 110, namely, the information regarding the data link mode negotiated between the second USB-C power delivery controller (PDC) 312b and the peripheral device (PD) 114. Therefore, the first USB-C power delivery controller (PDC) 312a negotiates with the host device (HD) 110 for the host device (HD) 110 to communicate using the same the data link mode as was negotiated with the peripheral device (PD) 114. [Is this last sentence correct?] The host device (HD) 110 is then able to communicate with the peripheral device (PD) 114 in the negotiated data link mode.

Thereafter, as shown at step 626, the USB-C midspan device (MSD) 100, the host device (HD) 110 and the peripheral device (PD) 114 communicate substantially seamlessly in the negotiated data link mode, according to aspects of the embodiments. The host device (HD) 110 and the peripheral device (PD) 114 communicate through the USB-C midspan device (MSD) 100 as if the MSD 100 was not present and as if the two devices were merely connected via a cable, according to further aspects of the embodiments. Also, both the host device (HD) 110 and the peripheral device (PD) 114 can receive power from the USB-C midspan device (MSD) 100 as required and requested, also according to aspects of the embodiments.

As described above, a start-up and operating process is discussed in reference to FIG. 6A-6C. The process is not meant to limit the aspects of the embodiments, or to suggest that the aspects of the embodiments should be implemented following the start-up process. The purpose of the above process is to facilitate the understanding of one or more aspects of the embodiments and to provide the reader with one or many possible implementations of the processes discussed herein. FIG. 6A-6C illustrates a flowchart of various steps performed during the process. The steps of FIG. 6A-6C are not intended to completely describe the process but only to illustrate some of the aspects discussed above.

This application may contain material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

The disclosed embodiments provide devices, systems, methods, processes, and modes for facilitating USB-C bi-directional data and/or video communication between the USB-C host device and the USB-C peripheral device while delivering charging power to the USB-C host device and/or the USB-C peripheral device over one or more of the data links where such bi-directional communication is carried out, the charging power being delivered and the USB-C bi-directional communication being performed through a USB-C midspan according to aspects of the embodiments. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

Although the features and elements of aspects of the embodiments are described being in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods or processes. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus, the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All United States patents and applications, foreign patents, and publications discussed above are hereby incorporated herein by reference in their entireties.

### INDUSTRIAL APPLICABILITY

To solve the aforementioned problems, the aspects of the embodiments are directed towards devices, systems, methods, processes, and modes for facilitating USB-C bi-directional data and/or video communication between the USB-C host device and the USB-C peripheral device while delivering charging power to one or more of these devices over one or more of the data links where the bi-directional communication is carried out. A midspan device delivers both the charging power and facilitates the USB-C bi-directional data and video communications according to these aspects of the embodiments.

It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

Although the features and elements of aspects of the embodiments are described as being in particular combinations, each feature or element may be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods or processes. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus, the embodiments are capable of many variations in detailed implementation that may be derived from the description contained herein by a person skilled in the art. No element, act, or instruction used in the description of the present application should be construed as critical or essential to the embodiments unless explicitly described as such. Also, as used herein, the article “a” is intended to include one or more items.

In addition, the above disclosed methods and processes are not meant to limit the aspects of the embodiments, or to suggest that the aspects of the embodiments should be implemented following the aforementioned methods and processes,. The purpose of the aforementioned methods and processes is to facilitate the understanding of one or more aspects of the embodiments and to provide the reader with one or many possible implementations of the processes discussed herein. It should be understood by one of ordinary skill in the art that the steps of the aforementioned methods and processes, may be performed in a different order and that some steps may be eliminated or substituted.

All United States patents and applications, foreign patents, and publications discussed above are hereby incorporated herein by reference in their entireties.

### ALTERNATE EMBODIMENTS

Alternate embodiments may be devised without departing from the spirit or the scope of the different aspects of the embodiments.

What is claimed is:

1. A midspan charging and data communication device (“midspan device”), the midspan device comprising:
(a) a first Universal Serial Bus Type-C (USB-C) port that is electrically connectable to a USB-C host device;
(b) a second USB-C port that is electrically connectable to a USB-C peripheral device; and
(c) USB-C midspan device processor and circuitry electrically connected to the first USB-C port and to the second USB-C port and configured to
(1) configure the first USB-C port to support USB data communication in a particular USB data link mode,
(2) configure the second USB-C port to support USB data communication in the particular USB data link mode, and
(3) at least one of
(A) deliver, upon the first USB-C port being further connected to the USB-C host device, power to the USB-C host device as requested by the USB-C host device, the power being delivered from the first USB-C port to the USB-C host device over a first data link between the USB-C host device and the first USB-C port, or
(B) deliver, upon the second USB-C port being further connected to the USB-C peripheral device, power to the USB-C peripheral device as requested by the USB-C peripheral device, the power being delivered from the second USB-C port to the USB-C peripheral device over a second data link between the USB-C peripheral device and the USB-C second port.

2. The midspan device of claim 1, wherein
(a) the USB-C midspan device processor and circuitry is further configured to
(1) enable USB data communication between the USB-C host device and the USB-C peripheral device in the particular USB data link mode upon the first USB-C port being further connected to the USB-C host device and the second USB-C port being further connected to the USB-C peripheral device, the USB data communication being carried out between the USB-C host device and the first USB-C port over the first data link, through the first USB-C port, the USB-C midspan device processor and circuitry, and the second USB-C port, and between the second USB-C port and the USB-C peripheral device over the second data link.

3. The midspan device of claim 1, wherein
(a) the first data link includes
(1) a USB-C physical connection between the USB-C host device and the first USB-C port, and
(2) the particular USB data link mode, and
(b) the second data link includes
(1) a USB-C physical connection between the USB-C peripheral device and the second USB-C port, and
(2) the particular USB data link mode.

4. The midspan device of claim 1, wherein
(a) the USB-C midspan device processor and circuitry is further configured to
(1) negotiate the particular data link mode with one of (i) the USB-C host device or (ii) the USB-C peripheral device and then negotiate the particular data link mode separately with another of (i) the USB-C host device or (ii) the USB-C peripheral device.

5. The midspan device of claim 1, wherein
(a) the particular data link mode is one of (i) a USB data-only mode, (ii) USB Alt mode, or (iii) a mixed mode, 6. The midspan device of claim 1, wherein
(a) the USB-C midspan device processor and circuitry is further configured to
(1) negotiate, with the USB-C host device, the power delivery required by the USB-C host device, and
(2) deliver the power to the USB-C host device as requested by the USB-C host device based on the power delivery negotiated with the USB-C host device.

7. The midspan device of claim 1, wherein
(a) the USB-C midspan device processor and circuitry is further configured to
(1) negotiate, with the USB-C peripheral device, the power delivery required by the USB-C peripheral device, and
(2) deliver the power to the USB-C peripheral device as requested by the USB-C peripheral device based on the power delivery negotiated with the USB-C peripheral device.

8. The midspan device of claim 1, wherein
(a) a first USB-C cable electrically connects the first USB-C port to the USB-C host device,
(b) a second USB-C cable electrically connects the second USB-C port to the USB-C peripheral device, and
(c) the USB-C midspan device processor and circuitry is further configured to
(1) re-drive USB data, control, and Alt mode signals that pass through the midspan device processor and circuitry so that
(A) the first USB-C cable is able to carry the USB data, control, and Alt mode signals over a distance that is at most equal to a specified maximum cable length, and
(B) the second USB-C cable is able to further carry the USB data, control, and Alt mode signals over a further distance that is at most equal to the specified maximum cable length,
(C) the USB data, control, and Alt mode signals are thereby able to be carried over a combined distance that is at most equal to twice the specified maximum cable length.

9. The midspan device of claim 1, wherein
(a) a first USB-C cable electrically connects the first USB-C port to the USB-C host device,
(b) a second USB-C cable electrically connects the second USB-C port to the USB-C peripheral device,
(c) a first configuration channel (CC) line extends from within the USB-C midspan device processor and circuitry over the first USB-C cable to within the USB-C host device,
(d) a second configuration channel (CC) line extends from within the USB-C midspan device processor and circuitry over the second USB-C cable to within the USB-C peripheral device, and
(e) the first configuration channel (CC) line is isolated from the second configuration channel (CC) line so that the USB-C host device and the USB-C peripheral device do not communicate directly over any configuration channel (CC) line.

10. The midspan device of claim 9, wherein
(a) the first configuration channel (CC) line is isolated from the second configuration channel (CC) line so that
(1) power delivery with the USB-C host device is negotiated separately from power delivery with the USB-C peripheral device, and
(2) a data link mode required by the USB-C peripheral device is presented to the USB-C host device separately from the power delivery being negotiated with the USB-C peripheral device.

11. The midspan device of claim 9, wherein
(a) the USB-C midspan device processor and circuitry is further configured to
(1) use the second configuration channel (CC) line to obtain capabilities of the USB-C peripheral device,
(2) use the first configuration channel (CC) line to present the capabilities of the USB-C peripheral device to the USB-C host device,
(3) simulate, to the USB-C host device via the first configuration channel (CC) line, that the USB-C peripheral device is directly connected to the USB-C host device, thereby hiding, from the USB-C host device, the midspan device that is actually directly connected to the USB-C host device, and
(4) simulate, to the USB-C peripheral device via the second configuration channel (CC) line, that the USB-C host device is directly connected to the USB-C peripheral device, thereby hiding, from the USB-C peripheral device, the midspan device that is actually directly connected to the USB-C peripheral device.

12. A midspan charging and data communication device (“midspan device”), the midspan device comprising:
(a) a first USB-C port that is electrically connectable to a USB-C host device;
(b) a second USB-C port that is electrically connectable to a USB-C peripheral device; and
(c) USB-C midspan device processor and circuitry electrically connected to the USB-C first port and to the second USB-C port and configured to
(1) configure the first USB-C port to support bi-directional data communication in a negotiated data link mode,
(2) configure the second USB-C port to support bi-directional data communication in the negotiated data link mode,
(3) at least one of
(A) deliver, upon the first USB-C port being further connected to the USB-C host device, power to the USB-C host device as requested by the USB-C host device, the power being delivered from the first USB-C port to the USB-C host device over a first data link between the USB-C host device and the first USB-C port, the first data link including (i) a first USB-C cable electrically connecting the first USB-C port to the USB-C host device and (ii) the negotiated data link mode, or
(B) deliver, upon the second USB-C port being further connected to the USB-C peripheral device, power to the USB-C peripheral device as requested by the USB-C peripheral device, the power being delivered from the second USB-C port to the USB-C peripheral device over a second data link between the USB-C peripheral device and the second USB-C port, the second data link including (i) a second USB-C cable electrically connecting the second USB-C port to the USB-C peripheral device and (ii) the negotiated data link mode.

13. The USB-C midspan device of claim 12, wherein
(a) USB data and Alt mode signals pass between the USB-C host device and the USB-C peripheral device through the USB-C midspan device in the negotiated data link mode upon the first USB-C port being further connected to the USB-C host device and the second USB-C port being further connected to the USB-C peripheral device, such that
(1) the USB data and Alt mode signals pass between the USB-C host device and the first USB-C port over the first data link, through the first USB-C port, the USB-C midspan device, and the second USB-C port, and between the second USB-C port and the USB-C peripheral device over the second data link.

14. The midspan device of claim 12, wherein
(a) the negotiated data link mode is negotiated between the USB-C midspan device processor and circuitry and one of (i) the USB-C host device or (ii) the USB-C peripheral device and then negotiated separately between the USB-C midspan device processor and circuitry and another of (i) the USB-C host device or (ii) the USB-C peripheral device.

15. The midspan device of claim 12, wherein
(a) the negotiated data link mode is one of (i) a USB data-only mode or (ii) a USB Alt mode.

16. The USB-C midspan device of claim 12, wherein
(a) the USB-C midspan device processor and circuitry is further configured to
(1) negotiate, with the USB-C host device, the power delivery required by the USB-C host device in accordance with the USB Implementers Forum (USB-IF) specification, and
(2) deliver the power to the USB-C host device in accordance with the USB-IF specification as requested by the USB-C host device based on the power delivery negotiated with the USB-C host device.

17. The USB-C midspan device of claim 12, wherein
(a) the USB-C midspan device processor and circuitry is further configured to
(1) negotiate, with the USB-C peripheral device, the power delivery required by the USB-C peripheral device in accordance with the USB Implementers Forum (USB-IF) specification, and
(2) deliver the power to the USB-C peripheral device in accordance with the USB-IF specification as requested by the USB-C peripheral device based on the power delivery negotiated with the USB-C peripheral device.

18. The USB-C midspan device of claim 12, wherein
(a) the USB-C midspan device processor and circuitry is further configured to
(1) re-drive USB data, control, and Alt mode signals that pass through the midspan device processor and circuitry so that
(A) the first USB-C cable is able to carry the USB data, control, and Alt mode signals over a distance that is at most equal to a specified maximum cable length. and
(B) the second USB-C cable is able to further carry the USB data, control, and Alt mode signals over a further distance that is at most equal to the specified maximum cable length,
(C) the USB data, control, and Alt mode signals are thereby able to be carried over a combined distance that is at most equal to twice the specified maximum cable length.

19. The midspan device of claim 12, wherein
(a) the USB-C midspan device processor and circuitry is further configured to, at least one of,
(1) hide presence of the midspan device from the USB-C host device by simulating, to the USB-C host device, that the USB-C peripheral device is directly connected to the USB-C host device in place of the midspan device that is actually directly connected to the USB-C host device, or
(2) hide presence of the midspan device from the USB-C peripheral device by separately simulating, to the USB-C peripheral device, that the USB-C host device is directly connected to the USB-C peripheral device in place of the USB-C midspan device that is actually directly connected to the USB-C peripheral device.

20. A midspan charging and data communication device (“midspan device”), the midspan device comprising:
(a) a first Universal Serial Bus Type-C (USB-C) port that is electrically connectable to a USB-C host device;
(b) a second USB-C port that is electrically connectable to a USB-C peripheral device;
(c) USB-C midspan device processor and circuitry electrically connected to the first USB-C port and to the second USB-C port and configured to
(1) configure the first USB-C port to support bi-directional USB data communication in a particular USB data link mode, the particular data link mode being one of (i) a USB data-only mode or (ii) a USB Alt mode,
(2) configure the second USB-C port to support bi-directional USB data communication in the particular USB data link mode,
(3) deliver, upon the first USB-C port being further connected to the USB-C host device through a first USB-C cable, power to the USB-C host device as requested by the USB-C host device in accordance with the USB Implementers Forum (USB-IF) specification, the power being delivered from the first USB-C port to the USB-C host device over a first data link between the USB-C host device and the first USB-C port, the first data link including (i) the first USB-C cable and (ii) the particular data link mode, and
(4) deliver, upon the second USB-C port being further connected to the USB-C peripheral device through a second USB-C cable, power to the USB-C peripheral device as requested by the USB-C peripheral device in accordance with the USB-IF specification, the power being delivered from the second USB-C port to the USB-C peripheral device over a second data link between the USB-C peripheral device and the second USB-C port, the second data link including (i) the second USB-C cable and (ii) the particular data link mode,
(d) wherein USB data and Alt mode signals pass between the USB-C host device and the USB-C peripheral device through the USB-C midspan device in the negotiated data link mode upon the first USB-C port being further connected to the USB-C host device and the second USB-C port being further connected to the USB-C peripheral device, such that
(1) the USB data and Alt mode signals pass between the USB-C host device and the first USB-C port over the first data link, through the first USB-C port, the USB-C midspan device, and the second USB-C port, and between the second USB-C port and the USB-C peripheral device over the second data link.
